(19) United States
(12) Patent Application Publication
(10) Pub. No.: US 2004/0172446 A1
(43) Pub. Date: Sep. 2, 2004

(54) Data capture and management system

(76) Inventors: Matthew M. Dorman, Potomac, MD (US); Portia B. Altimus, Bowie, MD (US); David D. Webb, Odenton, MD (US); Shelby N. Brewer, West River, MD (US)

Correspondence Address: DICKSTEIN SHAPIRO MORIN & OSHINSKY LLP, 2101 L STREET NW, WASHINGTON, DC, 20037-1526, US

(21) Appl. No.: 10/631,849

(22) Filed: Aug. 1, 2003

Related U.S. Application Data
(60) Provisional application No. 60/399,713, filed on Aug. 1, 2002.

(51) Int. Cl. G06F 15/16

(52) U.S. Cl. 709/203

(57) ABSTRACT

The present invention includes a field module for remote electronic data collection that captures and stores patient care information in the field and securely forwards it to a host server for integration. In accordance with an exemplary embodiment of the invention, a wireless personal digital assistant (PDA) is used to capture and store client information at the point of care during a client's visit. Client information and a visitation schedule is securely downloaded from the host server system through a wireless system. The invention also includes an online module for use by central office staff, which performs back office functions such as billing and a console module, which is used to dynamically update existing forms or create entirely new applications.

### CROSS-REFERENCE TO RELATED APPLICATIONS

This application claims priority under 35 USC §119 to U.S. provisional patent application No. 60/399,713, filed Aug. 1, 2002, the entire contents of which is incorporated herein by reference.

### FIELD OF THE INVENTION

This invention relates to the field of data capture, increased productivity and management of data. In particular, this invention relates to an improved method for capturing, monitoring, documenting, reporting and administering patient behavior and health care information in the behavioral health care industry.

### BACKGROUND OF THE INVENTION

A behavioral health care data management system is inherently laden with many issues that adversely effect its productivity. A large component of these problems stem from the record keeping requirements of any system. The types of record keeping data include tracking both clients and employees and the employee interactions with the health care entity's clients as well as maintaining the substantial medical data of the patients. The creation and maintenance of client records can thus be overwhelming. Moreover, the medical information component can track many different aspects of a client's care; for example, a treatment plan, medications, contact information, visit information, and notes associated with any of the above categories. Additionally, health care management employees are responsible for managing client visits and the ‘paperwork’ associated with that visit. In many cases, employees in the field either complete the paperwork contemporaneously with the visit, or at some later time. This paperwork must be subsequently integrated with the rest of the client's file, which can also dramatically downgrade a system's potential productivity.

Maintaining the data related to a health care provider's client visitation schedule can also be demanding. Besides requiring that the provider have the client's medical information with them to be effective during the visit, e.g., the treatment plan, medications, etc, the client visitation schedule can also change. That change requires acquiring and tracking the appropriate client files and information associated with the client appointment.

Using traditional paper records to accomplish these myriad of tasks is time consuming. In recent years, steps have been made to have computer systems replace paper in order to increase system productivity and data accuracy. Some examples of systems where paper has been reduced include electronic filings in the court system, electronic filings at the United States Patent and Trademark Office, time entry systems and Point of Sale (PoS) systems. In PoS systems, for example, a sale at a cash register records the sale for accounting purposes, debits customers accounts if they charge their purchases and performs inventory updates and automated re-ordering all at once.

Since many client records are maintained electronically, any paper records created must be converted into an electronic form. Therefore, it would be advantageous to initially create the records electronically; but this would require that health care employees have access to electronic data collection devices, e.g., computers, PDA's, etc., during the acquisition of client related data.

The use of electronic data collection devices creates an additional issue: connectivity. If there is a host electronic data collection system, information can be collected and entered at the host site, or at a place networked with that site. However, with mobile health care workers that are in the field, there exists an inherent logistical problem of how their “remote” electronic data collection device is connected to and exchanges data with the host system. Dial-up (through a modem) and Internet connections require locating and connecting to a telephone or Internet portal. Wireless systems require being within range of the transceiving system to work.

Once a remote system is connected, there remains the choice of how the data should be optimally exchanged (where optimally means more efficiently, speedily, securely, and accurately). In certain synchronization contexts, a remote user is in constant communication with a host system. Although applications that run synchronously permit real time acquisition of data, the application and the data integrity generated by the application is threatened should the communication become interrupted. For example, communication may be interrupted; the remote user travels out of range of the host system, or if weather disrupts communication links.

In synchronization contexts, users are typically required to exit the application that they are currently running in order to permit communication and transfer of data with a host system. Furthermore, synchronization requires determining whether significant amounts of data have been changed before beginning the synchronization process or transferring large amounts of unnecessary data that have not been altered.

An additional problem occurs when dealing with health care records. Government laws, such as HIPAA, require privacy, e.g., strict security, with the use and handling of a health care records. These laws and associated rules establish fundamental security standards for health care records regardless of the form in which they are maintained (e.g., paper or electronic records). Computer systems, whether they are host or remote, are also subject to these requirements.

In view of the foregoing problems, there is a need in the art for an electronic data collection system that seamlessly and securely receives, collects, and transmits health care data in the field and integrates that data with the data maintained on the host server.

### BRIEF SUMMARY OF THE INVENTION

The present invention provides a remote electronic data collection system and method that captures and stores patient care information in the field and forwards that data to a host server for integration. In accordance with an exemplary embodiment of the invention, a wireless personal digital assistant (PDA) is used to capture and store client information at the point of care during a client's visit. Client information and a visitation schedule is securely downloaded from the host server through a wireless system. Data is collected by the field user during a client visit and then subsequent to the visit, the client's additional visit data information is forwarded to a host server system through a secure wireless connection. In addition to the above central office (server) and field (client) modules, another server-based module is used to dynamically generate updates and/or create entirely new enterprise applications.

### BRIEF DESCRIPTION OF THE DRAWINGS

The above and other features and advantages of the invention will be more readily understood from the following detailed description of the invention, which is provided in connection with the accompanying drawings:

FIG. 1 is an overview diagram of the main components illustrative of an exemplary embodiment of the invention;

FIG. 2A is a diagram of the computer system in accordance with exemplary embodiment of the invention;

FIG. 2B is an exemplary diagram of the transmission of XML blocks between a client and the server;

FIG. 2C is a block diagram showing the major components of the client module and the server modules;

FIG. 3 is a representative screen display of a client list in accordance with an exemplary embodiment of the invention;

FIG. 4 is a flow chart depicting an operational flow of the client module, in accordance with an exemplary embodiment of the invention;

FIG. 5 is a representative screen display of a client entry template in accordance with an exemplary embodiment of the invention;

FIG. 6 is a representative screen display of a client's information in accordance with an exemplary embodiment of the invention;

FIG. 7 is a flow chart depicting an operational flow of the client view module, in accordance with an exemplary embodiment of the invention;

FIG. 8 is a representative screen display of a client's medication and treatment plan in accordance with an exemplary embodiment of the invention;

FIG. 9 is a representative screen display of a client visit list in accordance with an exemplary embodiment of the invention;

FIG. 10 is a representative screen display of a employee assignment list in accordance with an exemplary embodiment of the invention;

FIG. 11 is a flow chart depicting an operational flow of the personnel module, in accordance with an exemplary embodiment of the invention;

FIG. 12 is a representative screen display of a employee list in accordance with an exemplary embodiment of the invention;

FIG. 13 is a representative screen display of a employee entry template in accordance with an exemplary embodiment of the invention;

FIG. 14 is a representative screen display of a employee planner in accordance with an exemplary embodiment of the invention;

FIG. 15 is a flow chart depicting an operational flow of the personnel view module, in accordance with an exemplary embodiment of the invention;

FIG. 16 is a representative screen display of a employee information in accordance with an exemplary embodiment of the invention;

FIG. 17 is a representative screen display of a client assignment list in accordance with an exemplary embodiment of the invention;

FIG. 18 is a flow chart depicting an operational flow of the login, in accordance with an exemplary embodiment of the invention;

FIG. 19 is a representative PDA-login screen display in accordance with an exemplary embodiment of the invention;

FIG. 20 is a representative PDA screen display of a schedule of a day for an employee in accordance with an exemplary embodiment of the invention;

FIG. 21 is a flow chart depicting an operational flow of the daily client schedule, in accordance with an exemplary embodiment of the invention;

FIG. 22 is a flow chart depicting an operational flow of the individual encounter, in accordance with an exemplary embodiment of the invention;

FIG. 23 is a representative PDA screen display of adding an additional encounter in accordance with an exemplary embodiment of the invention;

FIG. 24 is another PDA screen display of a schedule of the day in accordance with an exemplary embodiment of the invention;

FIG. 25 is a flow chart depicting an operational flow of the group encounter, in accordance with an exemplary embodiment of the invention;

FIG.26 is a representative PDA screen display of a transmittal confirmation screen in accordance with an exemplary embodiment of the invention;

FIG. 27 is a representative PDA screen display of a client visit list reflecting a successfully sent encounter in accordance with an exemplary embodiment of the invention;

FIG. 28 is a representative PDA screen display of a client's information in accordance with an exemplary embodiment of the invention;

FIG. 29 is a representative PDA screen display of a categories of encounter questions in accordance with an exemplary embodiment of the invention;

FIG. 30 is a representative PDA screen display of a signature capture screen in accordance with an exemplary embodiment of the invention;

FIG. 31 is a representative PDA screen display of a client's treatment goals in accordance with an exemplary embodiment of the invention,

FIG. 32 is a representative PDA screen display of a client's medications in accordance with an exemplary embodiment of the invention;

FIG. 33 is a representative PDA screen display of a client's contact information in accordance with an exemplary embodiment of the invention;

FIG. 34 is a representative PDA screen display of a group encounter client list in accordance with an exemplary embodiment of the invention;

FIG. 35 is a representative PDA screen display of a notes in accordance with an exemplary embodiment of the invention;

FIGS. 36a-b are a spreadsheet showing the different roles and levels of security assignable to a user;

FIGS. 37a-d show reports analyzing the system data;

FIG. 38 is a representative online module screen for reviewing selected visits for a batch;

FIG. 39 is a representative online module screen for editing batched claims;

FIG. 40 is a representative online module screen for reconciling batched claims;

FIG. 41 is a representative console module screen for editing a partners list;

FIG. 42 is a representative console module screen showing the details of a particular partner application;

FIG. 43 is a representative console module screen for listing the categories;

FIG. 44 is a representative console module screen for editing the categories;

FIG. 45(a)-(f) are console module screen depicting categories, questions and answers as displayed on a PDA used by field staff using a PALM emulator;

FIG. 46 is a representative console module screen for editing a question and answers to that question;

FIG. 47 is a representative console module screen for set up and configuration; and

FIG. 48(a)-(e) are various exemplary screens of the MobileForm Online module.

### DETAILED DESCRIPTION OF THE INVENTION

In the following detailed description, reference is made to the accompanying drawings, which form a part hereof, and show by way of illustration specific embodiments how the invention may be practiced. These embodiments are described in sufficient detail to enable those of ordinary skill in the art to make and use the invention, and it is to be understood that structural, logical or procedural changes may be made to the specific embodiments disclosed without departing from the spirit and scope of the present invention.

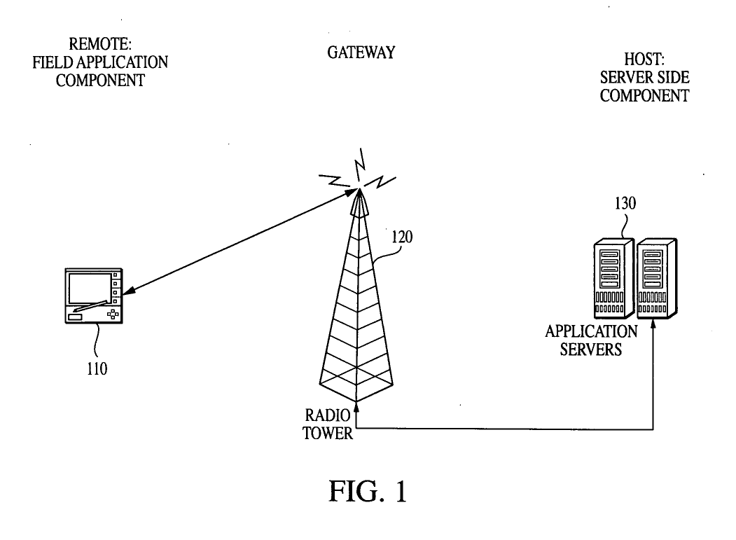

In an exemplary embodiment, an electronic health care data capture and management system program is provided that collects, stores and manages information. The system consists of three main components: a server component 130 (e.g., the host system), a field component 110 (e.g., the client or remote system), and the connection means 120 between the server and the field components. For simplicity, the connection means between the server and the client will be called a gateway or gateway connection. FIG. 1 depicts a simplified diagram of the main aspects of the electronic behavioral healthcare data management invention. Two components (the online module and the console module) of the electronic health care data management program reside on the server 130 along with the corresponding databases. The field application component (MobileForm Field) 110 runs on a remotely operated handheld component of the electronic health care data management program, which interacts with the online component of the electronic health care management system resident on the server system 130 to transmit and receive data from/to the server, as well as view and modify the data that has been received from the server 130, and submit the modified data to the server 130 at a later time. Other than transceiving information with the program running on the server 130, the program on the field application program runs independently on the field component 110. The field application program is used by providers to perform data entry at the point of contact with the client. Additionally, a server-based dynamic application generator facilitates updating forms and/or form versions as well as providing for the creation of entirely new enterprise applications. The server, therefore, actually has two programs or modules, an online module (MobileForm Online) and a console module (MobileForm Console). The online module interacts with the client side field module/program to electronically manage client health care. The console module interacts with the online module to update forms and/or versions or when fielding entirely new enterprise applications, which are downloaded to the client side field module by the online module.

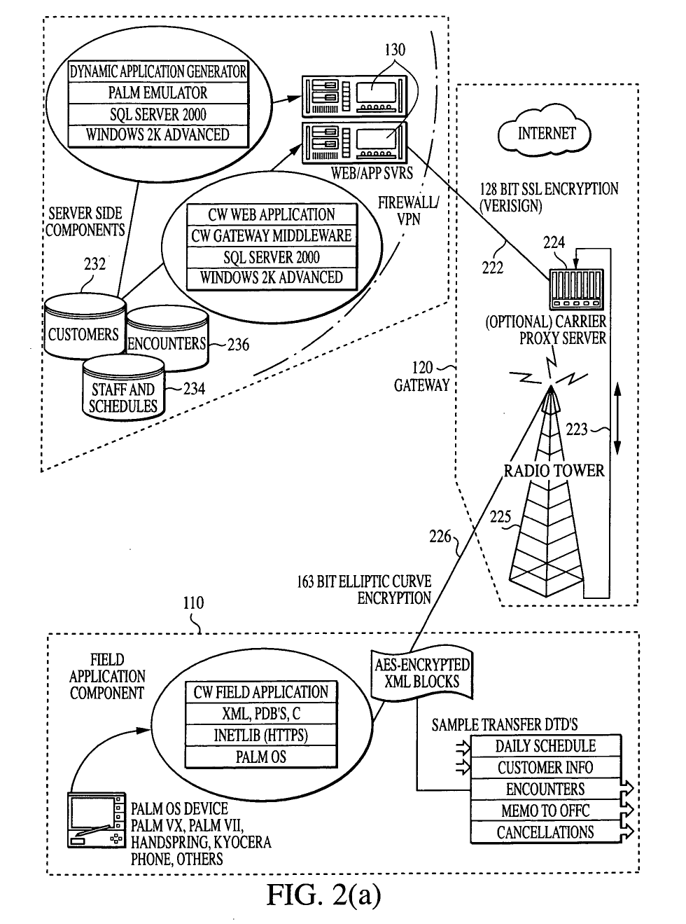

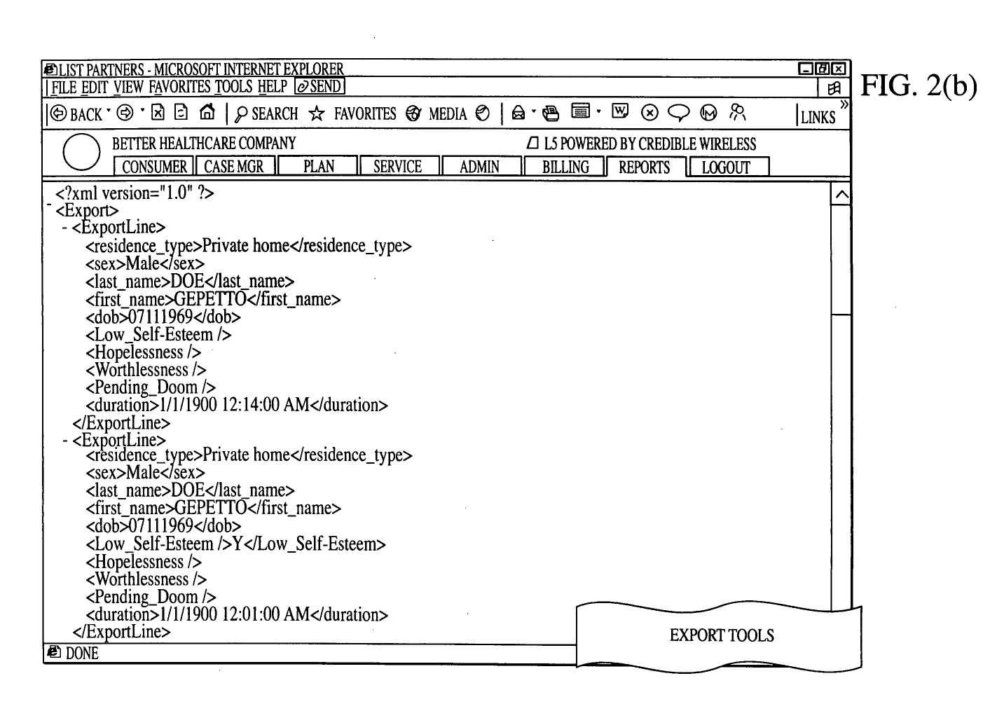

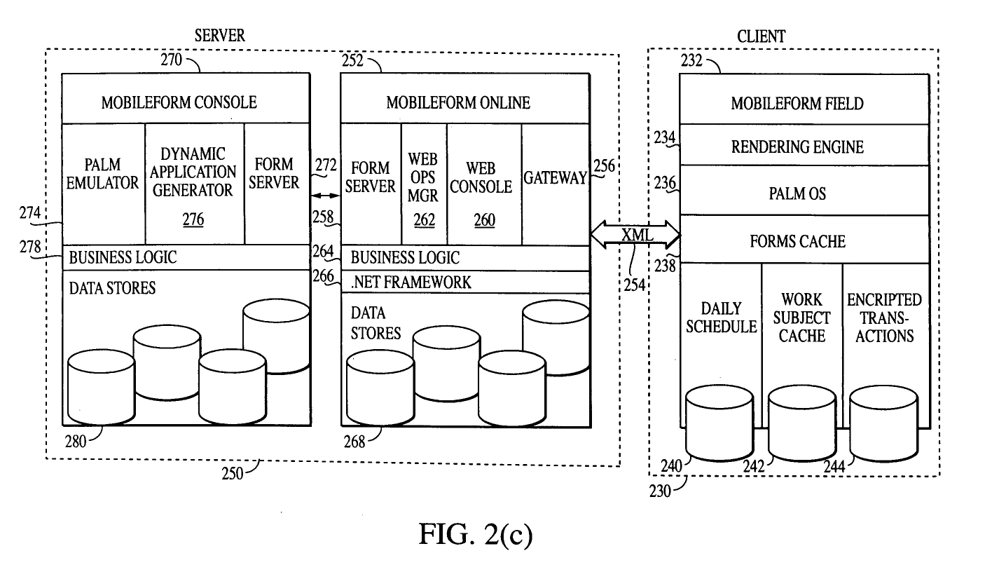

The functions highlighted below are allocated to submodules of MobileForm Online as illustrated in FIG. 2C. MobileForm Online performs the following functions and will be discussed in depth below with reference to FIG. 2C:

Allows central office staff to review, edit, print and approve service forms that arrive from field staff throughout the day—Web Console submodule.

Allows central office staff to list, search, view and update customer and field staff records—Web Console submodule.

Supports viewing schedules by day, week, month or team; allows adding service appointments and blocking out time; supports an integrated view of events and reminders attached to customer and staff files—Web Console submodule.

Allows setting up work teams to facilitate schedule management and supervision; allows optional assignment of teams or individual staff to customers—Web Console submodule.

Provides for choice from over 15 predetermined and preformatted reports to analyze staff productivity—Web Console submodule.

Supports importing customer or staff records from an external (legacy) system, automatically updates existing records using external ID field—Web Operations Manager and business logic submodules.

Supports exporting service records with or without attached form data—Web Operations Manager and business logic submodules.

Supports advanced security features by allowing control of the number of security profiles needed, and what rights each profile has; users can be assigned to any profile; staff access to customer files can be granted using a supervisor hierarchy or direct assignments—Web Console and Web Operations Manager.

MobileForm Console is used by administrators to dynamically generate new applications. That is, MobileForm Console is a dynamic application generator that not only facilitates updating current forms and/or form versions but also facilitates the creation of entirely new enterprise wireless applications. MobileForm Console performs the following principal functions and will be discussed in greater detail later:

Configures high-level application behaviors such as: Business information, logos, colors, application rules, terminology—Form Server submodule.

Uses web-based data dictionary to configure up to 30 customer fields for field staff and customer records, and to control which fields are displayed on the web screens—Dynamic Applications Generator submodule.

MobileForm Console features a web-based utility to outline and build multiple data capture forms, with no knowledge of programming required. Data capture forms can optionally use labels, spacers and lines to control the look and flow of the form on the handheld device—Dynamic Applications Generator submodule.

Builds a new form, or copy from a large library of pre-defined business forms and customize as needed—Dynamic Applications Generator submodule.

Releases new forms and form versions to the field. Field staff will automatically be prompted to download and receive the new form definitions on their handheld devices—Form Server submodule.

In addition to the two server-based modules, there is a PDA-based client (field application) module (MobileForm Field) that performs the following functions and will be described in greater detail below:

Ability to select wireless, wireline or hotsync mode for each handheld user (field staff). In hotsync mode, a field staff user may download his daily schedule (at least the first ten encounters) before he/she leaves home from the server via his/her home computer with the same security—PALM—OS submodule.

Store-and-forward model works seamlessly in all modes—whether connected throughout the day or not—PALM—OS submodule.

Ability to download schedules on demand; ability to schedule repeat or follow-up services—PALM—OS submodule.

Customer (client) details are displayed before starting a service (encounter) and can be accessed at any time—PALM—OS submodule.

Unscheduled services can be added “on the fly”; a customer's record can be retrieved from the server, pulled from local cache or a new record can be created—PALM—OS submodule.

An automatic time clock runs in the background when a service is started; running time shows on the device in the upper right hand corner—PALM—OS submodule.

Each service (encounter) is associated with a customizable data capture form that is completed in the field—Form Server submodule.

Digitized signature capture is accomplished by signing directly on the device with a stylus—PALM—OS and Rendering Engine submodules.

FIG. 2A illustrates, in greater detail, the embodiment of the system shown in FIG. 1.

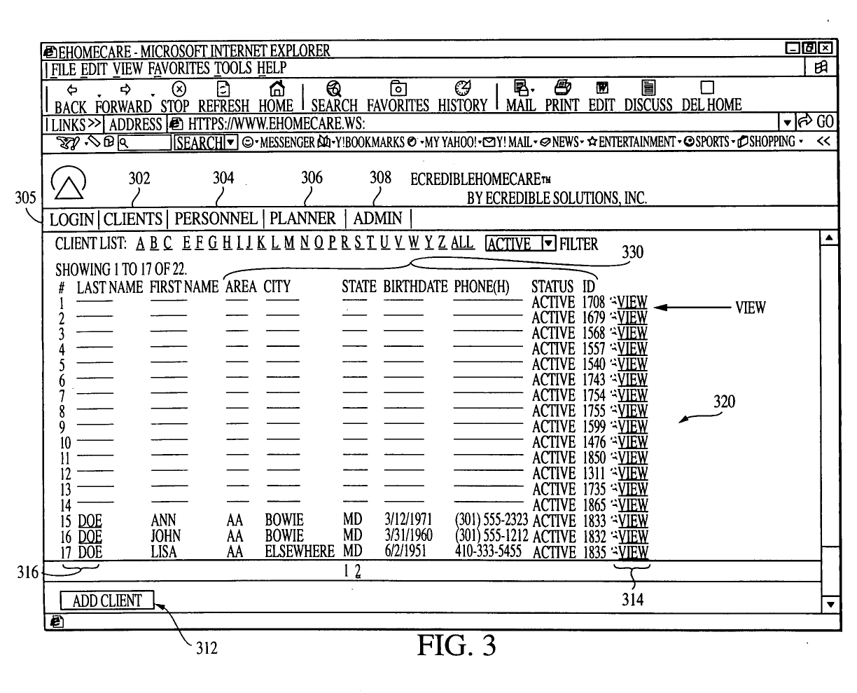

As noted above, the program (online module) that resides on the server 130 has four application areas: “Clients” 302, “Personnel” 304, “Planner” 306, and “Administration” 308 as shown in FIG. 3. The “Clients” 302 area permits central office staff to create, modify and maintain information about clients. The “Personnel” 304 area permits central office staff to create, modify and maintain information about employees. The “Planner” 306 area permits central office staff to create, modify, and maintain schedule information about encounters (e.g., an employee's schedule of encounters with clients for a specific day). The “Administration” 308 area permits administration of the databases, report generation, question and question category generation and other executive functions such as billing to be described below.

Returning to FIG. 2A, the server program maintains and manages data in three databases related to information retained in the behavioral care system: behavioral health care clients (customers) 232, behavioral health care employees 234, and encounters 236 (e.g., an employee visits with a client (s)) with behavioral care clients. The three databases are interrelated; for example, information about the client is maintained in the customer database 232, which is related to which employee the client has had an encounter with (information about the employee is stored in the employee database 234) and also related to one or more encounters. Information about an encounter is stored in the encounter database 236. Additional databases (not shown) include an insurance database and a billing database. The insurance database may, for example, include information such as a phone number (for coverage verification), a mailing address, copay and deductible information, etc. The billing database may include copies of submitted bills, dates of service, date submitted, client name, insurance carrier, group number, member number, an internal tracking number, the billed amount, etc.

One aspect of the customer database 232 is a client's personal information. This information includes, for example, a client's name, age, address, date of birth, phone numbers, diagnosis, emergency contact information, spouse, and insurance provider information. Another aspect maintained by database 232 is information about a client's medications. This information includes: the name of the medication, the dosage, the frequency of dose, the provider (e.g., the care provider that that prescribed the medication) and the starting date of that medication. An example of a format for medication data is “Cogentin, 1 mg, BID, Dr. Smith, Started Nov. 16, 2000.” Many other formats are contemplated. The client's treatment plan is also stored in the customer database 232. For example, a treatment plan could be “Client will follow the recommendations of his psychiatrist and attend all psychiatric appointments without prompting by a certain date.” The client database 232 is linked with the employee database 234 and encounter database 236 to provide information about a client's encounters and employee who is currently assigned to work with that client.

The employee database 234 maintains personal information about an employee. This information includes an employee's name, age, address, date of birth, phone numbers, emergency contact information, and spouse. The employee database 234 is linked to with the client and encounter databases 232, 236, to provide information about this employee's encounters and the clients that the employee is currently assigned to work with. An employee in the employee database 234 is associated with a client, or clients, in the customer database 232, and associated with an encounter, or encounters, in the encounter database 236.

The encounter database 236 maintains information relating to an employee's contact with a client. For example, for each encounter, the database contains questions to be posed by the employee to the client and the client's answers (subsequent to an encounter). Each answer is marked to reflect the time and date that each section and question was answered. An encounter is either a private appointment (e.g., an employee encounters one client at a given time) or a group appointment (e.g., an employee encounters more than one client at the same time). Thus, when an individual encounter is displayed, a single client name associated with that encounter is displayed. When a group appointment is scheduled, a list of those client's associated with the encounter is displayed. An encounter in the encounter database 236 is associated with a client, or clients in the customer database 232, are associated with an employee or employees in the employee database 234.

In the preferred embodiment, the server-based modules run on a Windows-based operating system that is connected to the Internet. Windows 2000 Advanced is one example of an operating system. However, any operating system may be used with the present invention. SQL Server 2000 serves as the exemplary database management software, although any database management software can be used. For security measures, the server utilizes a firewall to minimize unpermitted access to the data.

The online module is accessed via the Internet. The minimum system requirements for a user accessing the online module is a computer system that employs an Internet browser that provides SSL (secure socket level) protocols on the Internet browser. Any type of browser, or SSL based products may be used. In an exemplary embodiment, Internet Explorer 4.0 or higher is used, which provides SSL and “https” capability. With these minimum system requirements and a valid username and password the system can be accessed worldwide.

As illustrated in FIG. 2A, the server 130 and (client field application) 110 components communicate through a gateway 120. Transmission between these two components is executed in XML blocks as is commonly known and used by those skilled in the art. An exemplary transmission of XML blocks between a client (field application) 110 and the server 130 is shown in FIG. 2B. It is expected that other communications protocols can be used. In a preferred embodiment and as shown in FIG. 2A, the gateway 120 consists of a communication line 222, a carrier proxy server 224, a radio tower 225, a communication line 223 between the proxy server 224 and the radio tower 225, and wireless communication media/line/link 226.

When transmitting data between server 130 and proxy server 224, communication line 222 provides 128 bit SSL Encryption for security. In this manner, the communication line 222 maintains the “https” security encryption. When transmitting between data proxy server 224 and PDA 110, the data is encrypted with 163 bit Elliptic Curve Encryption; this encryption is standard Palm OS encryption, which is maintained in the communication path between proxy server 224 and PDA 110 by communication lines 223, 226 and tower 223. It should be noted that any type of encryption can be used. The proxy server 224 converts information between Elliptic Curve Encryption and SSL encryption, depending on the direction of flow of information. For example, information flowing from the PDA 110 to the server 130 will be converted from Elliptic Curve Encryption to SSL encryption by the proxy server 224. This could result in a temporary security hole where the conversion takes place and the data is not encrypted with either the Elliptic Curve Encryption or the SSL encryption. The data remains protected, however, with an additional layer of security that the system has implemented. For example, recent U.S. government standards—NIST advanced encryption standard (AES)—are used for each XML block. Thus, the XML blocks remain encrypted with at least one level of security between the server 130 and the PDA 110 and with the exception of a brief moment at server 224, the XML blocks have two levels of security.

Server 130 also includes the console module, which interacts with the online module, and uses the same databases: customers 232, encounters 236, staff and schedules 234 and other databases (not shown) including insurance and billing. The console module dynamically updates forms in use by field staff and/or dynamically generates entirely new applications from a set of master forms. The console module also includes a PALM emulator for viewing the updated or new forms prior to sending the forms to the field module via the online module. The console module will also work with any handheld computing device emulator. The updates or newly generated forms are saved in a forms server and can then be forwarded to the online module. The online module forwards the forms to field staff from its forms server via a gateway. The field module's forms cache stores the forms in a compressed form.

The field (client side) component, e.g., the remote system, 110 (FIGS. 1 & 2A) in a preferred embodiment is a Palm based PDA (e.g., a Palm Vx, Palm VIIx, Palm i705, Handspring, or Kyocera phone ) running Palm operating system 3.5 or higher with wireless modem capability and appropriate communications software within the Palm. The PDA may be configured to include a micro-disc and/or flash memory. Ideally, the employee using the PDA will be within transmission distance, so that when the employee desires an upload or download of information, the employee will not have to relocate to do so.

As indicated above, the,PDA 110 does not maintain continuous communications with the server 130 (although the PDA 110 is adapted to establish communication at any time); as indicated above, the PDA 110 uses a Store and Forward feature. This feature allows the PDA 110 to run independently of the online module of the server 130, with the exception of the times that it downloads from the online module of the server 130 or transmits information to the server (online module) 130. Once information is downloaded from the online module of the server 130, an employee can execute programs on the PDA 110 using that information. For example, once the employee has established contact with the online module of the server 130 and downloaded the schedule for the day, the employee can then view the information downloaded and perform visits. Information modified by the employee is transferred to the online module of the server 130 at a later time. The Store and Forward feature does not require information to be transmitted from the PDA 110 to the server 130 contemporaneously with the data being modified. Thus, if an employee travels out of range of the wireless service then the employee can transmit data when the employee is later within range of the wireless service.

The significant data in the electronic health care management system are the client encounters and the information gathered from those encounters. This information is collected by an employee(s) in the field who gathers the information on the field component 110 (FIGS. 1 and 2) contemporaneous with the contact with the client(s). The information relates not only to the type of contact, e.g., individual or group encounter, but also the status of the contact e.g., the client cancelled the encounter, the client failed to show up for that appointment, the employee cancelled the encounter, or the encounter took place. As part of an individual encounter, the employee asks the client a series of questions related to his/her care—the interview. These answers are recorded by the employee contemporaneous with the client providing them. At the end of the session, the client and the employee provide their signature by “signing” on the field component 110. An overview description of interview handling follows:

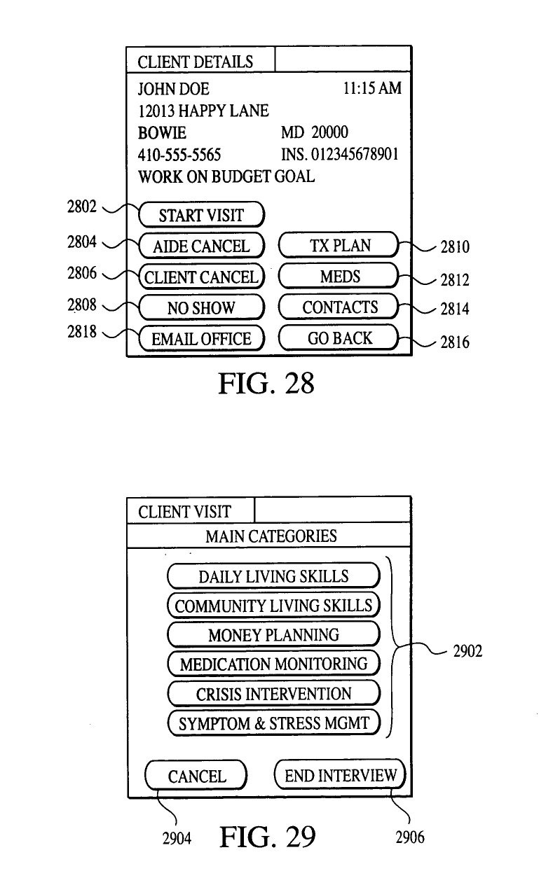

An interview is the definition and structure of a form that can be filled out on a handheld computing device. The form (for example, FIG. 28) is used to collect data by a user in a structured format. An interview consists of categories (for example, FIG. 29), questions and answers where each category is a section of the form and categories are structured in a hierarchical relationship—categories contain other categories or one or more questions. Each question is a standard type of form control such as checkbox or text field. Each answer is a predetermined response to a question used for all controls except text entry. Form definitions are created on the server and stored as records in the server database.

Scheduled items map to a single interview that must be downloaded to the handheld before the interview and form can be filled out. Multiple interviews may reside on the handheld and can be updated by downloading a new interview definition. New interviews are pushed down to the handheld by scheduling an item using the service type related to that interview. Forms are dynamic and are completely driven by the interview definition. Forms can be added and updated without updating the software application on the handheld.

Hierarchical XML containing the interview definition is downloaded to the handheld. The interview definition contains category, question, and answer elements. The interviews are versioned so when a schedule is downloaded, the handheld can check to see if it has the latest version of the interview downloaded. The interview XML is processed recursively, creating records in the category, question, and answer databases on the handheld for each element. Interview definition is performed with input from a console user using the console module of the server. Attributes for each element are saved for form rendering, flow control logic, data file definition and data input constraints by the console module of the server. The saved element attributes are accessed by the online module of the server and forward subsequently to the field module for rendering and use in capturing data.

An interview save file is mapped into a single linear memory space of a specific size and layout determined by the interview definition. The interview parsing process flattens out the hierarchical interview definition into a continuous memory space. It is capable of storing all of the data collected by the forms. Each interview question and answer database record on the handheld stores an offset value into the save file. When a data form is completed and saved by the user, each form answer is written to a predetermined location in the memory space—the offset stored in the interview definition records. Each question type requires a specific amount of storage space in the memory to store the answer. The total size of the interview save file is the sum of all the question storage areas. For answers and categories that require a notes field, an index into a packed record is stored in the save file instead of the full notes. A packed record grows only as large as the data it needs to save, whereas an interview save file is a predetermined size.

XML is generated to transfer the saved interview back to the server. A saved interview consists of category elements and answer ids and answer text. Only the minimal information needed to reconstruct the interview on the server is sent back. The saved interview definition in the server database for the current interview version is needed to reconstruct the view or printout of the interview. Answer ids that relate to answer records on the server database are stored on the handheld and sent for each predefined answer. Free text is saved as straight text to the save file. All data is sent encrypted to the server.

Use of the field component PDA, for example, might occur as follows: The employee at the beginning of the working day, starts the remote programming running on the PDA 110 and logs into the program (online module) running on the server 130 to get his/her schedule for the day. Using the assigned name and password, the server identifies the employee as an authorized user, and downloads the employee's schedule for the day. If the employee has more than ten scheduled encounters, only the first ten are downloaded. The employee goes to an encounter, records the information, saves it, and then uploads it to the online module on server 130. The questions asked by employee of a client during an encounter are part of the schedule of day data that is downloaded from the online module of the server 130 to the PDA 110. These questions, may have answer choices that are predetermined. For example, if the question is what color is the sky? The predetermined answer choices would include several different colors. An employee progresses through the day's schedule until all the encounters are processed-either by canceling an encounter or by completing the encounter. Should an employee be out of range for a period of time, or cannot establish a connection, then the employee later takes the stored responses and forwards them to the online module of the server 130.

The employee having filled out the ‘paperwork’ contemporaneously during the encounter with the client has no additional paperwork to do. Management, using different reports and techniques, can track the data to run different types of analysis. For example, management compares the number of times that client is actually encountered to the number of visits prescribed by the care provider or authorized by insurance. Or, for example, management determines all the employees who had contact with a specific client. There are numerous possibilities as to how the data can be analyzed.

FIG. 2C is a block diagram of the major components of the two server-based modules 250 (online and console) and the client module. The client (field application) module 230 (called MobileForm Field 232) has a rendering engine 234 and operates using PALM OS 236. The Forms Cache 238 contains a compressed version of the XML form description optimized for rendering. The rendering engine retrieves the compressed XML form description and generates the screens used on the remotely operated handheld computing device for data capture. The databases predominantly used by the client module are the daily schedule 240, work subject cache 242, and encrypted transaction 244. These semi-relational databases contain information such as the customer names and other customer information, the daily schedule of appointments (encounters) for a particular field staff user and encounter information. The field module, which runs on the remotely operated handheld computing device includes programs, such as the rendering engine, which are coded in C. The screens are linked one to the next.

There are two server-based modules—online (called MobileForm 252 Online) and console (called MobileForm Console). The online module communicates with the Forms Cache 238 of the PDA via XML blocks 254 using the gateway 256. The online module also has a Forms Server 258, a Web Console 260, a Web Operations Manager (Web Ops Mgr 262). The online module is also supported by a business logic segment 264 and .NET framework 266. The Data Stores 268 (databases) include customers, encounters, schedules, billing and insurance and are relational databases, which could be organized and related in a variety of ways. Both the online module and the console module are coded in MS ASP as Web Applications. MS ASP is Microsoft's web scripting language. The business logic for a given application is located in stored procedures in a database. The dynamic application generator (form builder) of the console module is also coded in MS ASP.

The main function of the console module (MobileForm Console 270) is to control the means by which data is managed and captured. That is, the console module updates forms for existing applications and creates new applications from a set of master forms. This allows the console module to control the means by which data is managed and captured. The console module includes a Forms Server 272 by which forms, which are updated or newly created forms are loaded into the online module for downloading to the field staff using PDAs. The console module also includes a PALM Emulator 274 whereby an authorized central staff user can view the updated or newly created forms. The console module also includes the dynamic application generator 276, which is used to dynamically update or create entirely new applications. The console module is also supported by business logic 278 and similar data stores 280 to those included in the online module.

The preferred embodiment operates as follows:

Operation of the Online Module of the Server Program

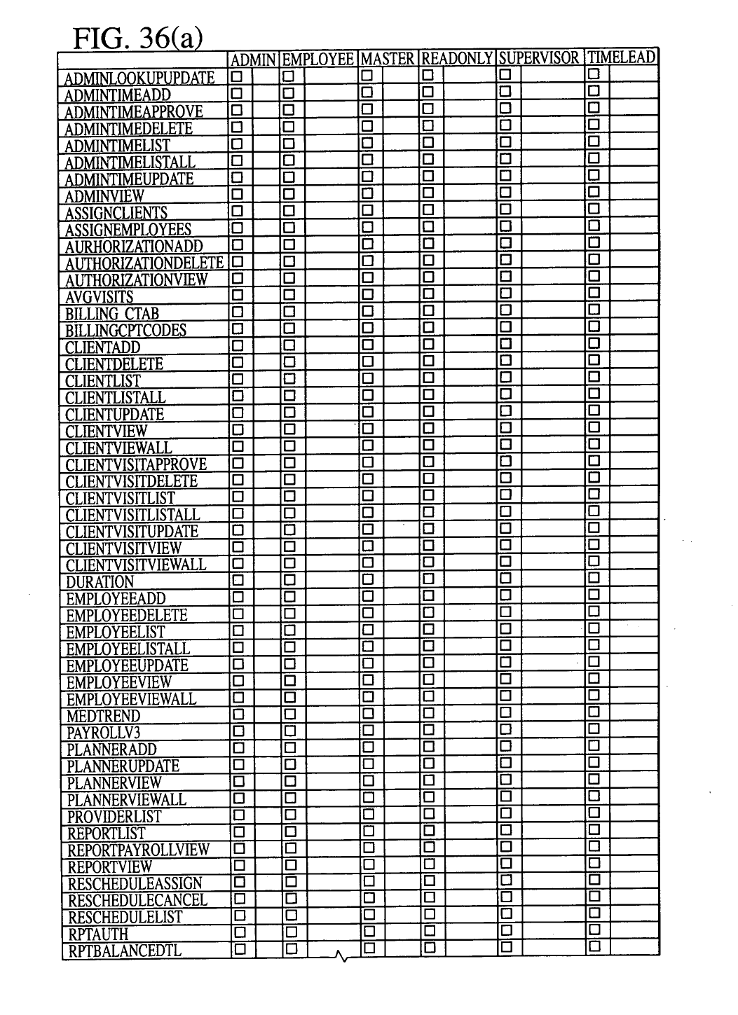

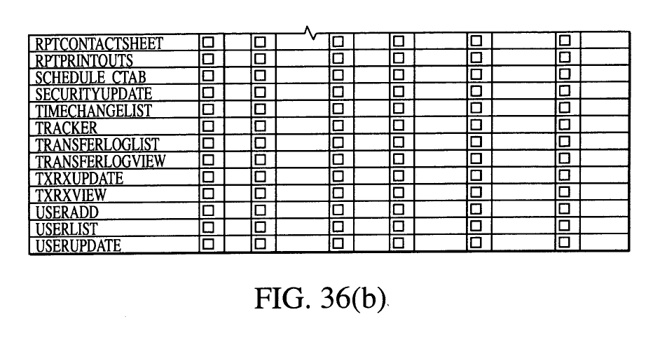

After accessing the online module and providing a valid username and password, the online module provides a graphical user interface (FIG. 3). The online module program menu bar choices provided, “Clients 302,” “Personnel 304,”, “Planner 306,” and “Admin 308”, shown in the screen display of FIG. 3. The operation of each of these choices, driven by the security level and role of the user, is described below. As shown in the spreadsheet illustrated in FIGS. 36a-b, there are several different roles and levels assignable to central office staff. The type and number of roles, and the rights that each of those roles have, is configurable. The individual rights (on the left) are not configurable as they are programmed in to match various functions in the program.

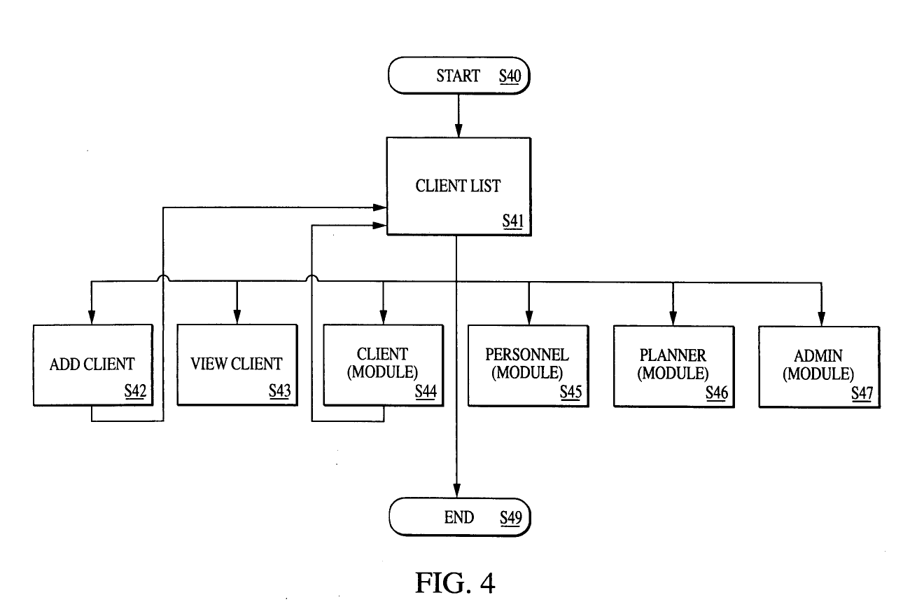

FIG. 4 depicts operational flow of the Client module. Execution of the program is directed to the Client module initially and the Client list screen is the first screen displayed as seen in FIG. 3. In most situations, program execution can “jump” from the execution of one of the modules to another module by clicking on the appropriate button 302-308 (FIG. 3). For example, while in the Client Module, clicking on the Personnel button 304 causes the program to cease execution of the Client Module program segment and begin execution of the program segment related to Personnel 304.

As shown in FIG. 4, after receiving an acceptable username and password (not shown), the system execution proceeds to process segment S41 where the Client List is then displayed. As shown in FIG. 3, a list of client names 320 is displayed along with additional identifying information about the client 330. For example, the client's area, e.g., county, the client's city and state, the client's birth date and phone number, and the client's status. If more than twenty clients exist in the database, the clients will be displayed in groups of that number. From this screen, a central office staff user has several options: adding a client, viewing a client's records, going to the “Personnel” module 304, the “Planner” module 306, or the “Admin” module 308, or ending program execution.

Returning to FIG. 3, if the central office staff user chooses to add a client by clicking on the “Add Client” button 312, then execution proceeds to program segment S42 as depicted in FIG. 4. If the central office staff user chooses to view an existing client, by clicking on the “view” label 314 associated with a client, execution proceeds to program segment S43. If the central office staff user chooses to go to the “Client” module, then execution proceeds to program segment S44, if the central office staff user chooses to go to “Personnel” module, then execution proceeds to program segment S45. If the central office staff user chooses to go to “Planner” module, then execution proceeds to program segment S46, and if the central office staff user chooses to go to “Administration” module, then execution proceeds to program segment S47.

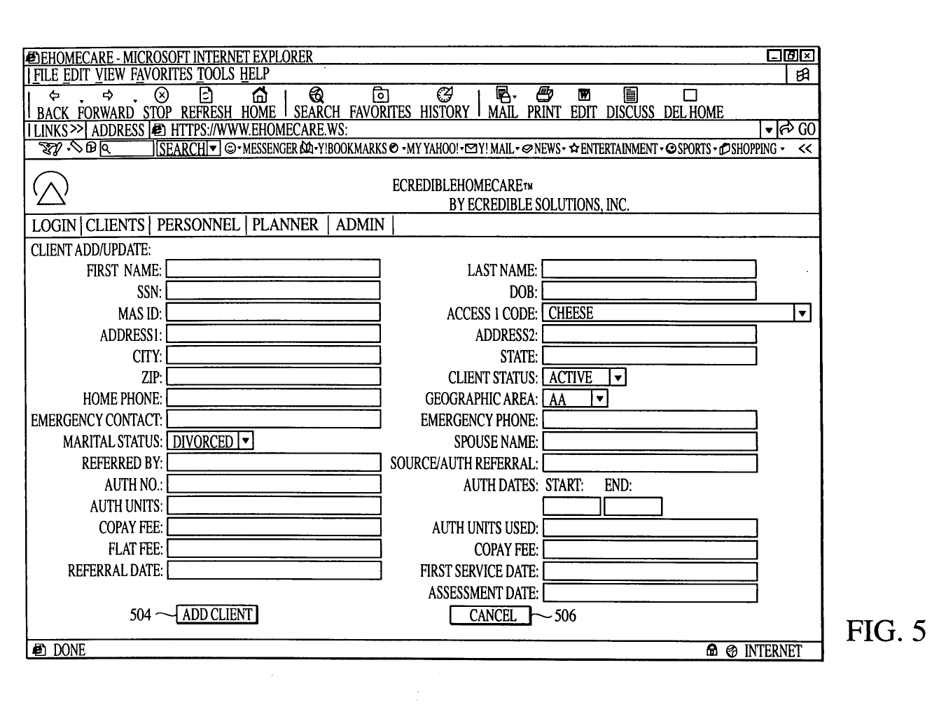

In program segment S42, a new screen is displayed providing the central office staff user a template for entering information as shown in FIG. 5. For example, a central office staff user may enter a client's name, address, phone numbers, and other contact information. After entering new client information, the central office staff user can click on the “Add Client” button 504 which stores the new client and accompanying information into the system database and execution proceeds to program segment S41. At any time while the Add client screen is displayed, a central office staff user can click on the “Cancel” button 506 which disregards any information entered on this screen and execution proceeds to program segment S41. If “Cancel” is entered, the new client and the new client information is not saved and program execution continues to program segment S41; the changes are saved only if the central office staff user clicks on the “Add Client” button 504 before clicking on any other option. For example, if the central office staff user clicks on the “Visits” button 506 before clicking on the “Add Client” button 504, then those changes will be lost.

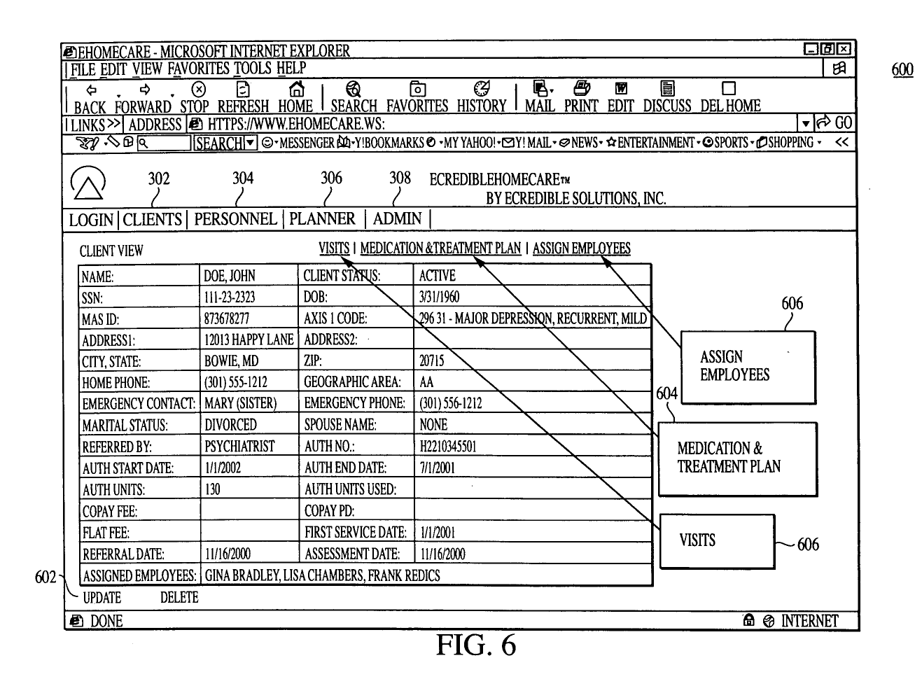

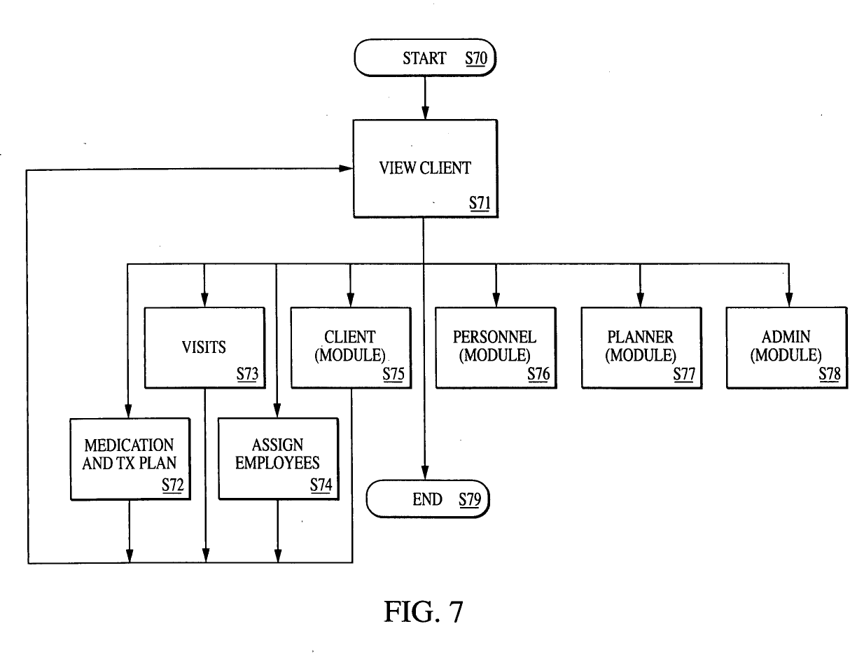

In program segment S43 “View Client”, execution continues to program segment S71, which is shown in FIGS. 6 and 7.

In program segment S44, the Client module has been chosen and execution continues to program segment S41.

In program segment S45, the Personnel Module has been chosen and execution continues to program segment S111, which is illustrated in FIG. 1.

In program segment S46, the Planner Module has been chosen and the central office staff user has the ability to execute different administrative protocols to manage the scheduled encounters.

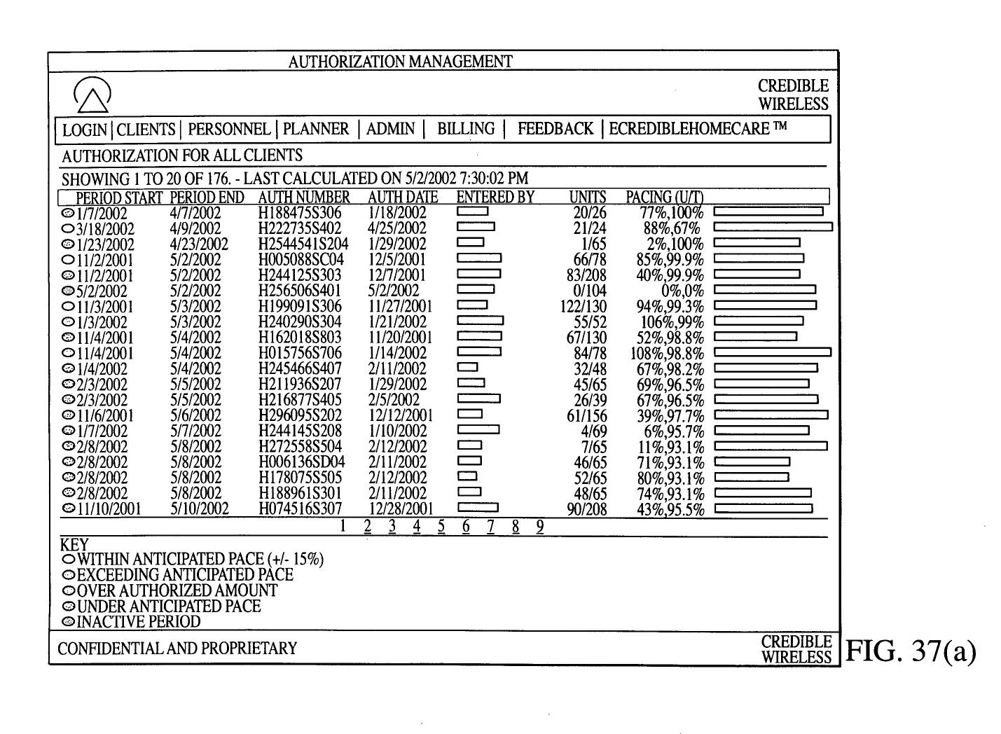

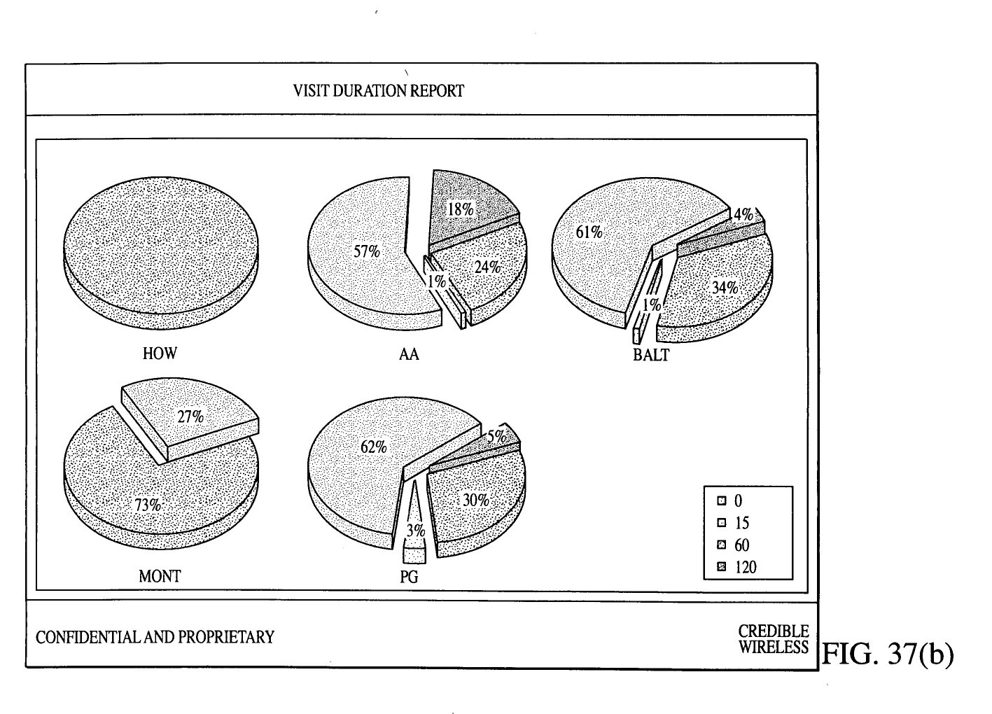

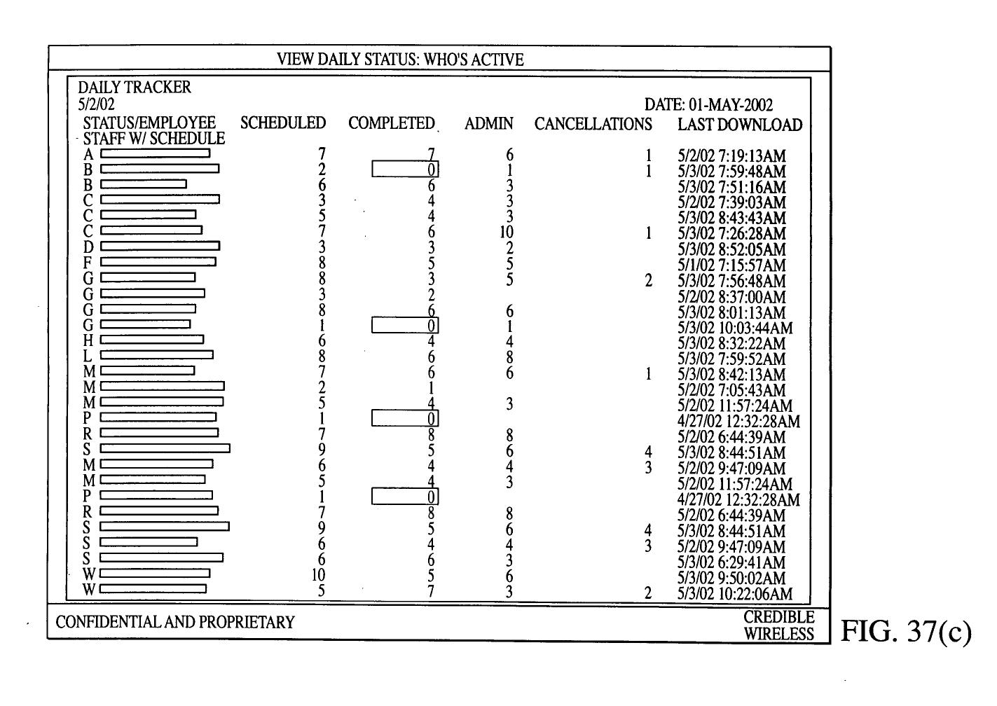

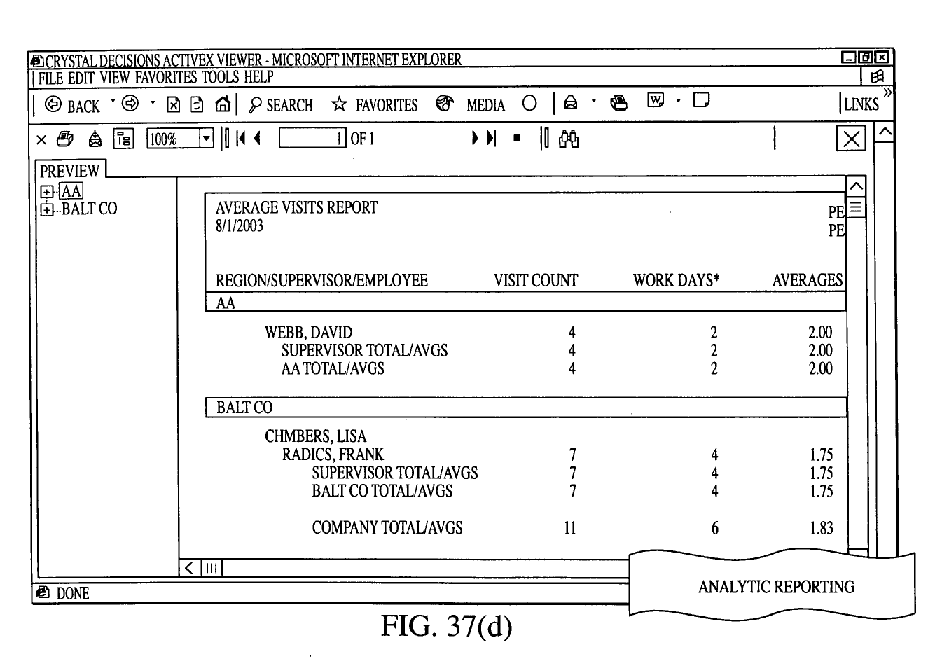

In the View Client program segment S47, the Administration Module has been chosen and the central office staff user has the ability to execute different administrative protocols to manage data and the overall system. For example, a central office staff user may generate reports that provide analysis on different aspects of the system's data. These reports include payroll, “at risk consumers,” “who's active,” “visit duration,” and “authorization management”, as shown in the reports included as FIGS. 37a-d. In addition to reports, other administrative functions, such as, but not limited to, reviewing and/or editing security profiles, central office staff and field staff user lists, look-up tables, transfer logs, visit queues, administrative time queues, reschedules, time changes and adding visits to field staff users' schedules.

Another option executed from FIG. 4 (but not shown) is billing. Upon uploading data from encounters, a central office staff user edits the encounter information and collects encounter information from a plurality of employees for a plurality of clients into batches of bills. The batches of bills may be, for example, sorted by day or insurance carrier or type of service.

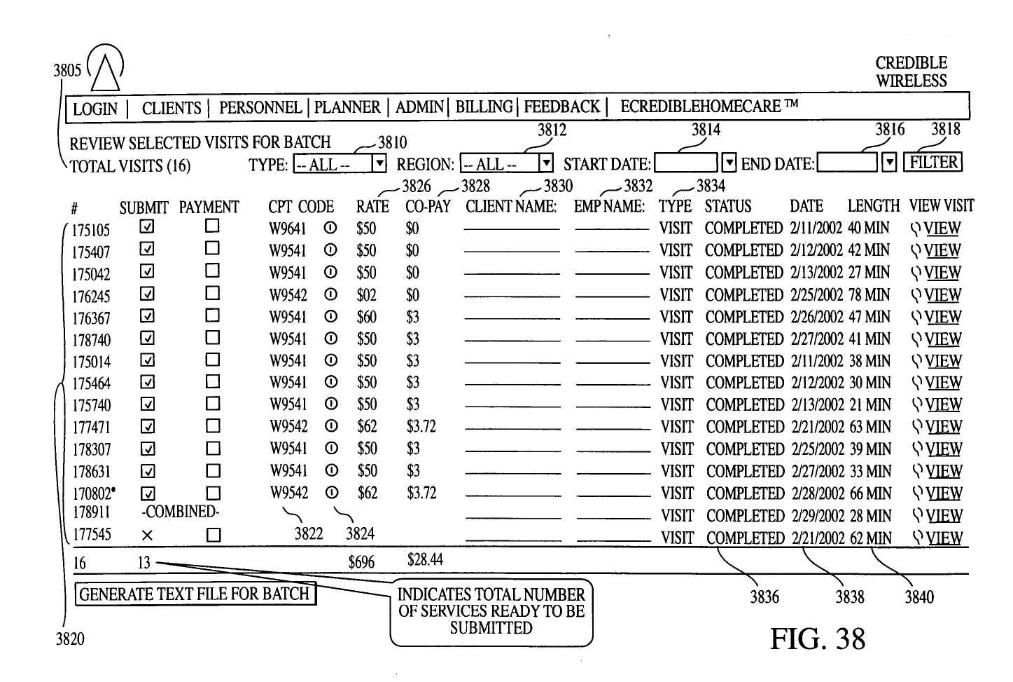

The first screen of the Billing program segment to be displayed is the REVIEW SELECTED VISITS for BATCH. An exemplary REVIEW SELECTED VISITS for BATCH screen is depicted as FIG. 38. The total number of visits 3805 is displayed. A filter may be applied by filling in the data in the TYPE filed 3810, the REGION field 3812, the START DATE field 3814, and/or the END DATE field 3816. Clicking on the FILTER button 3818 will apply the criteria in the fields to select only the encounters meeting the criteria.

Other information displayed on this screen includes a system assigned ID number 3820, a CPT 3822, a code 3824, a billing rate 3826, a copay amount 3828, the client's name 3830, the employee's name 3832, the type of service 3834, the status of the service 3836, the date of service 3838 and the length of service 3840. The central office staff user then has three options: submit, remove, and view.

Submit—The screen will open with the Submit box checked as the default for visits that are ready to be batched. The checked Submit box will not appear beside a visit that is not ready to be batched.

Remove—The screen will open with the Remove box unchecked. If it is desirable to exclude a visit, the Remove box can be checked.

Checking the Remove box will remove the selected visit from this batch and put it back in the queue for the next time a batch is generated.

View—Clicking the View button will open the Client Visit Update screen and allow viewing the details of the visit and updating, if applicable. If the visit is viewed, clicking the Back button on the browser will return to the REVIEW SELECTED VISITS for BATCH screen.

There is a Billing Administration screen (not shown). There are four options from this screen. The first option is to generate a batched claim. To do so, select GENERATE BATCH CLAIM FILE for CLIENT VISITS for GCX. A second option is to edit a batched claim by selecting BATCH LIST/PROCESS GCX EDITS. A third option is to manage payment records by selecting MANAGE PAYMENTS. A fourth and final option is to reconcile explanations of payments (EOPs) submitted by the insurance carrier with submitted claim records by selecting RECONCILE A PAYMENT REPORT FOR SUBMITTED BATCHES.

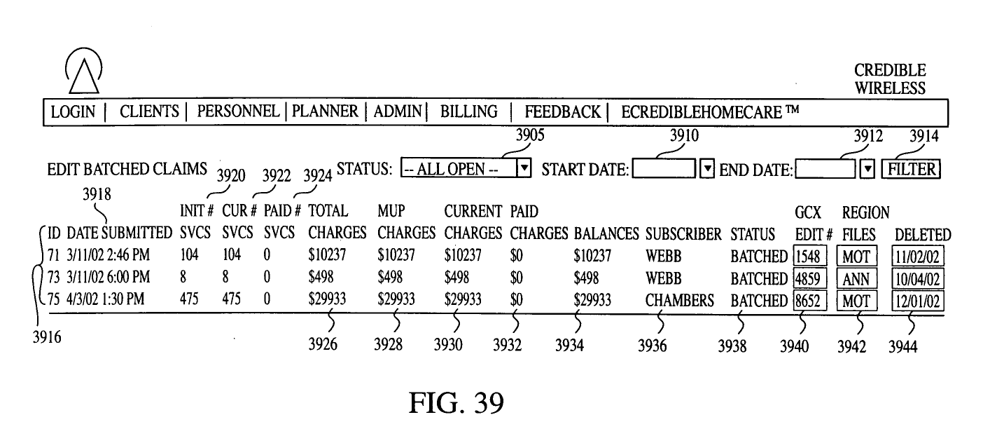

Upon selecting BATCH LIST/PROCESS GCX EDITS, the EDIT BATCH CLAIMS screen will be displayed as in FIG. 39. The data can be filtered by the status (all open, batched, closed, reconciled and updated) field 3905, start date 3910 and/or end date 3912. Clicking on the FILTER button 3914 will apply the criteria in the fields to select only the claims meeting the criteria.

Other information displayed on this screen includes an id 3916, a date the claim was submitted 3918, an initial number of services authorized 3920, a current number of authorized services 3922, the number of services paid 3924, the total charges 3926, the MUP charges 3928, the current charges 3930, the paid services 3932, the balance due 3934, the subscriber 3936, the status 3938, the GCX edit number 3940, the region file 3942 and the delete date 3944.

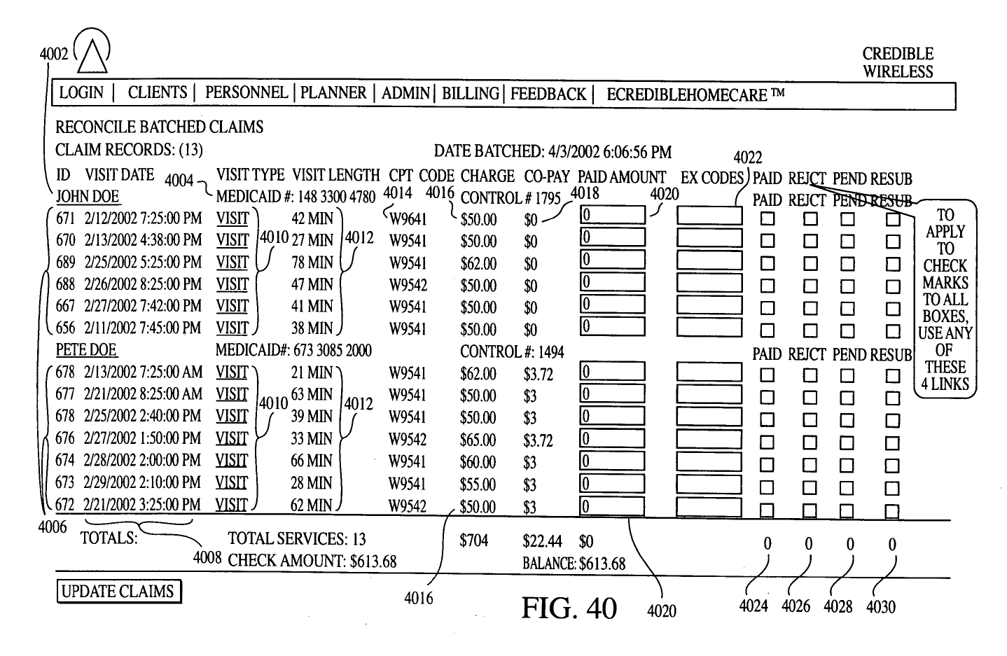

Upon selecting RECONCILE A PAYMENT REPORT for SUBMITTED BATCHES, the RECONCILE BATCH CLAIMS screen is displayed as in FIG. 40. The central office staff user will need an Explanation of Payment (EOP) report from a pay or to match the payments against the claim records. The central office staff user can mark any claim as paid.

The paid function is used to mark the claim as paid. Once the corresponding customer (client) claim record on the Explanation of Payment (EOP) has been located, the Paid box next to the corresponding claim record should be checked. The billed/charged amount will automatically appear in the Paid Amount box 4020. If the billed/charged payment does not match the EOP, then the amount paid from the EOP should be entered in the Paid Amount box.

Other information displayed on this screen includes the client's name 4002, the client's Medicaid number 4004, an ID number 4006, a visit date and time 4008, a visit type 4010, a visit length 4012, a CPT code 4014, the charges 4016, the copay amount 4018, the amount paid 4020, the exception code 4022 and four status buttons paid 4024, rejected 4026, pending 4028 and resubmitted 4030.

The MANAGE PAYMENTS option manages payment records. It allows central office staff to add payments that have been received, review EOPs to determine which batches it matches, verify correct calculation of payments, etc.

In program segment S71, the client information is displayed, as shown in FIG. 6, that corresponds to the client chosen from the client list as indicated in program segment S41. For example, the client information displays a client's name, date of birth, social security number, address, phone numbers, authorization information and assigned employees. A central office staff user can: update the client's personal information, go to the client's visits (e.g., encounters)., go to the client's medication and treatment plan, assign employees, or return to the Client List. From the FIG. 6 screen, a central office staff user can update any information in the client's personal information that is displayed on the screen in template form. Those changes are saved in the system by clicking on the “Update” button 602. If a central office staff user changes data in the client's personal information, the changes are saved only if the central office staff user clicks on the “Update” button 602 before clicking on any other option. For example, if the central office staff user clicks on the “Visits” button 606 before clicking on the “Update” button 602, then any changes will be lost.

If a central office staff user decides to go to a client's medication and treatment plan by clicking on the “Client's Medication and Treatment Plan” button 604, then execution continues to program segment S72 (FIG. 7). If a central office staff user decides to return to a client's visits information by clicking on the “Visits” 606 button, then execution continues to program segment S73. If a central office staff user decides to go to assign employees to the client by clicking on the “Assign Employees” button 606, then execution continues to program segment S74. If the user chooses to go to “Client” module 302, then execution proceeds to program segment, S75. If the central office staff user chooses to go to “Personnel” module 304, then execution proceeds to program segment S76. If the central office staff user chooses to go to “Planner” module 306, then execution proceeds to program segment S77. If the central office staff user chooses to go to “Administration” module 308, then execution proceeds to program segment S78.

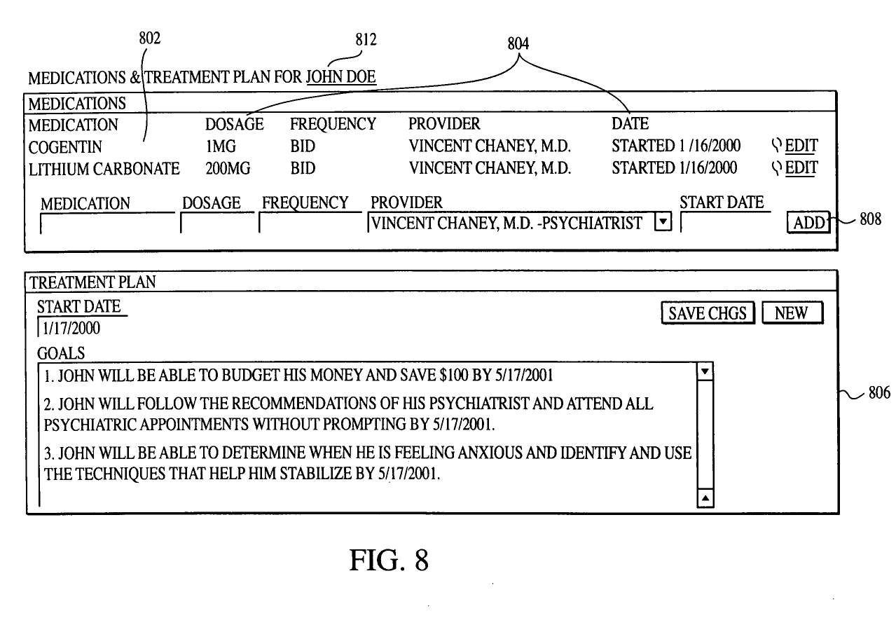

In program segment S72, a list of the client's medications 802 and corresponding information 804 is displayed, as shown in FIG. 8. A client's treatment plan 806 is also displayed. Here a central office staff user can view the medications, or add new medications 808, or modify existing medications. A central office staff user can also view the treatment plan 806, or add a new treatment plan, or modify an existing treatment plan. Execution returns the central office staff user back to program segment S71 by clicking on the client's name 812.

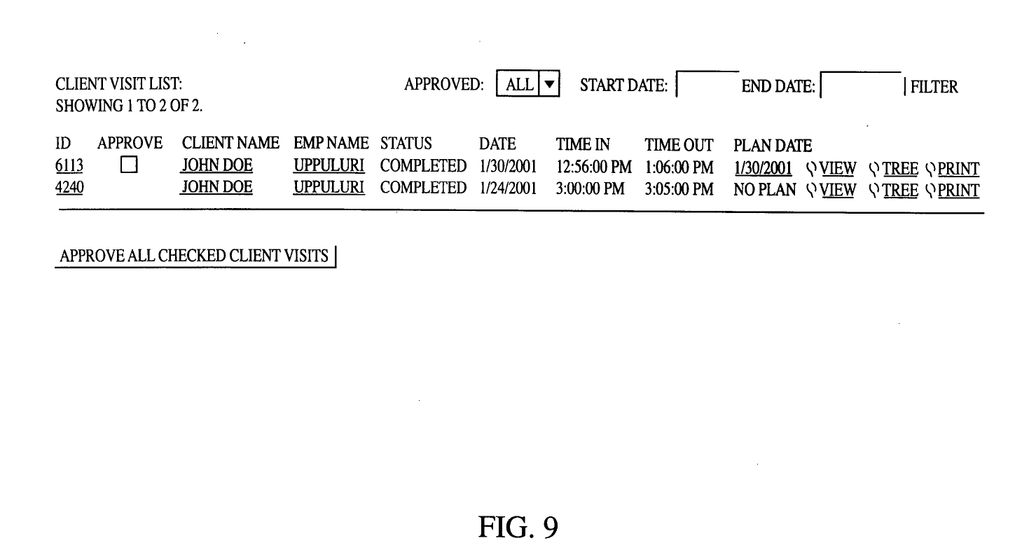

In program segment S73, a list of the client's health care visits is displayed, as seen in FIG. 9. A central office staff user can then approve any of the displayed visit(s). Approved client visits will be processed and billed. Execution returns back to program segment S71 by clicking on the client's name (not shown).

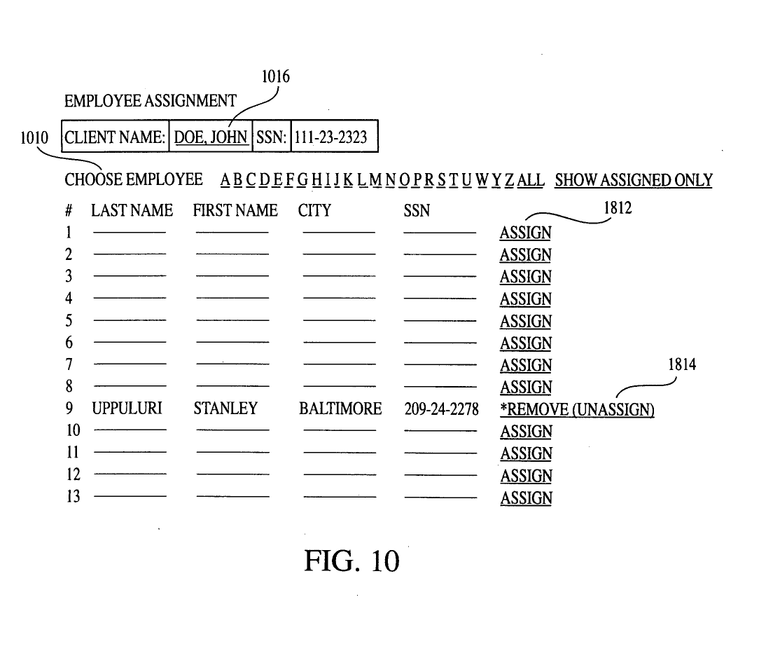

In program segment S74, as shown in FIG. 10, a list of employees 1010 appears which permits the central office staff user to assign listed employees to the client 1012. A central office staff user can also unassign employees from this client 1014. Execution returns back to program segment S71 by clicking on the client's name 1016.

In program segment S75, the Client module has been chosen and execution continues to program segment S71.

In program segment S76, the Personnel Module has been chosen and execution continues to program segment S111.

In program segment S77, the Planner Module has been chosen and the central office staff user has the ability to execute different administrative protocols to manage the Planner-the scheduled encounters.

In program segment S78, the Administration Module has been chosen and the central office staff user has the ability to execute different administrative protocols to manage the overall system such as described above.

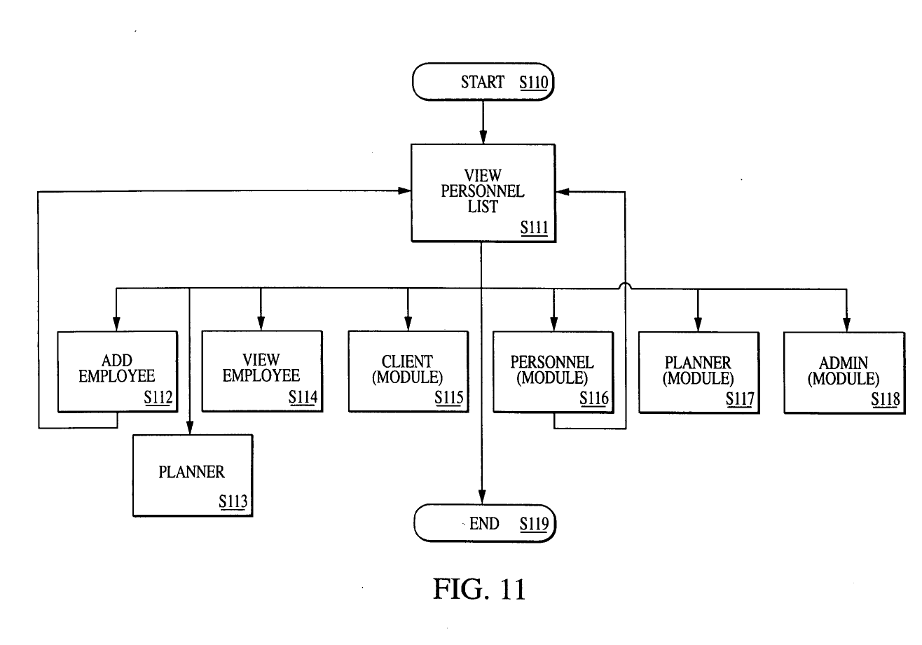

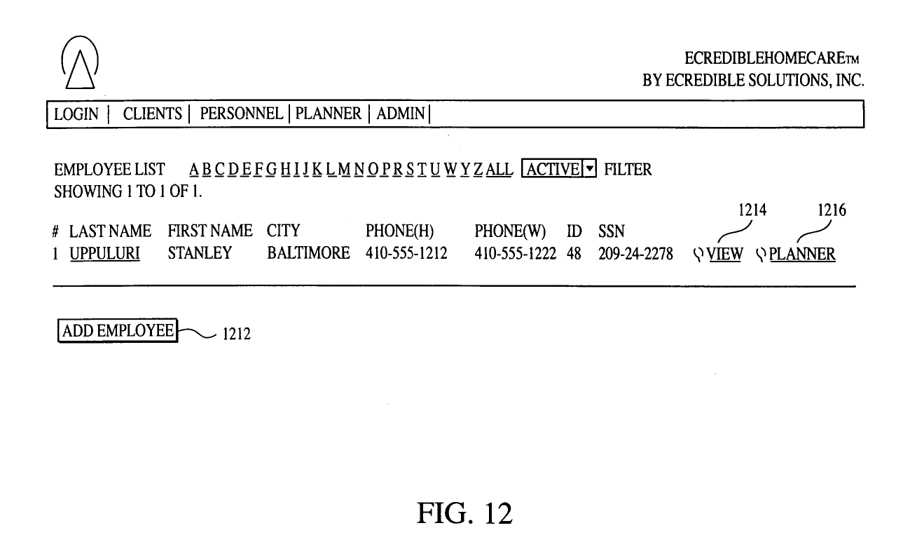

Referring to FIG. 11, in program segment S111, a list of employees is displayed which is shown in FIG. 12. Although only one employee is shown in FIG. 12, lists of employees, shown seventeen at a time, can be displayed. In FIG. 12, a central office staff user can: add a new employee, view an employee's information, view an employee's planner, or go to a module. If the central office staff user chooses to add an employee by clicking on the “Add Employee” button 1212, then execution proceeds to program segment S112. If the central office staff user chooses to go to the Planner, then execution proceeds to program segment S113. If the central office staff user chooses to view an existing employee by clicking on the “View” label 1214 associated with the selected employee, then execution proceeds to program segment S114. If the central office staff user chooses to go to “Client” module, then execution proceeds to program segment S115. If the central office staff user chooses to go to “Personnel” module, then execution proceeds to program segment S116. If the central office staff user chooses to go to “Planner” module, then execution proceeds to program segment S117. If the central office staff user chooses to go to “Administration” module, then execution proceeds to program segment S118.

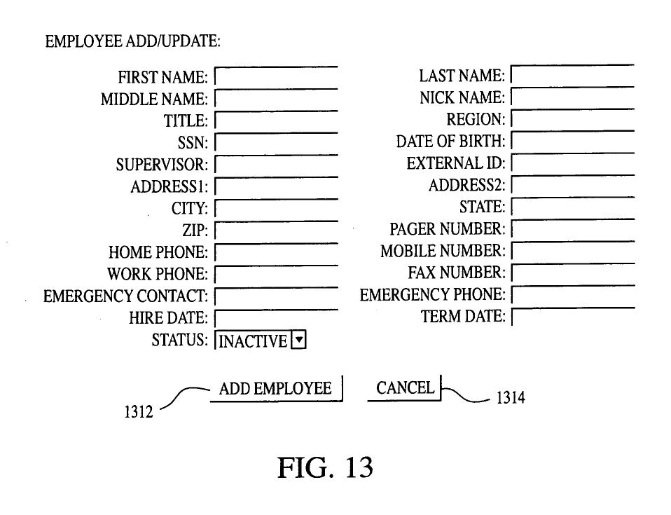

In program segment S112, an employee information screen is displayed in template form as shown in FIG. 13. After entering new employee information, the central office staff user can click on the “Add Employee” button 1312 which stores the new employee and accompanying information into the system database and execution proceeds to program segment S111 (FIG. 11). At any time while the Add employee screen is displayed, a central office staff user can click on the “Cancel” 1314 button, which disregards any information entered on this screen and execution proceeds to program segment S111 (FIG. 11). If a central office staff user does not click on the “Add employee” button 1312 before clicking any other button, the new employee and associated information will not be saved.

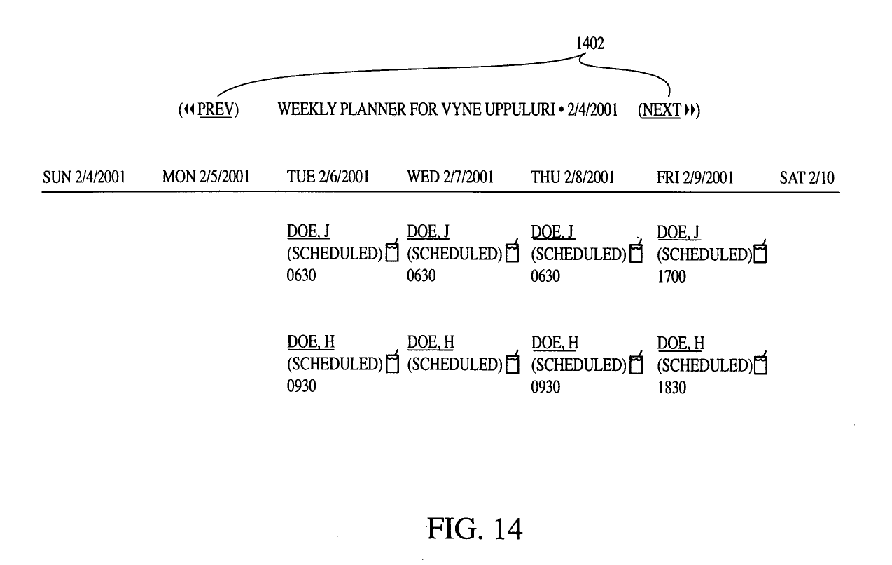

In program segment S113, a weekly calendar (i.e., planner) for this employee is displayed as shown in FIG. 14. The displayed week can be changed 1402 so that a different week will be displayed. A central office staff user can add additional encounters to the schedule or edit the currently existing encounters. Execution returns back to program segment S111 by clicking on the employee's name (not shown in FIG. 4).

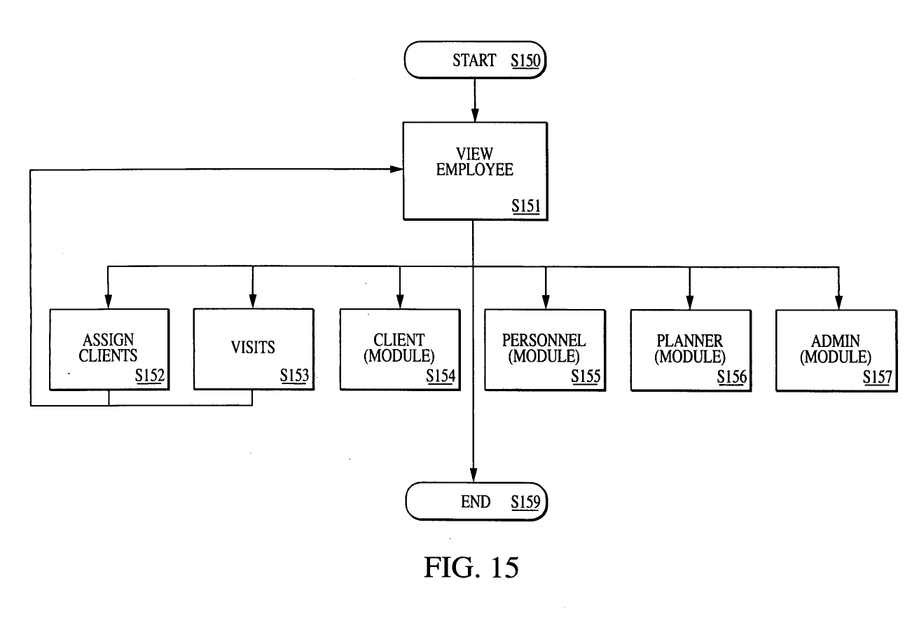

In program segment S114, execution continues to program segment S151 in FIG. 15.

In program segment S115, the Client module has been chosen and execution continues to program segment S71 in FIG. 7.

In program segment S116, the Personnel Module has been chosen and execution continues to program segment S111 in FIG. 11.

In program segment S117, the Planner Module has been chosen and the central office staff user has the ability to execute different administrative protocols to manage the Planner—the scheduled encounters. As in a doctor's/provider's office, appointments, for example, are made and entries corresponding to those entries are made in the appropriate provider's calendar.

In program segment S118, the Administration Module has been chosen and the central office staff user has the ability to execute different administrative protocols to manage the overall system such as described above.

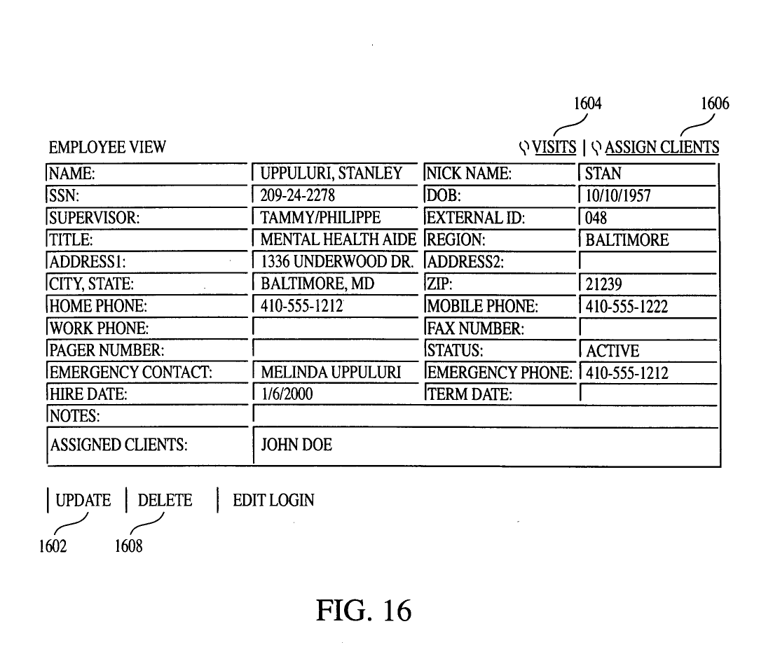

As shown in FIG. 15, in program segment S151, the desired employee's information is displayed in a template form as shown in FIG. 16. A central office staff user can: update the Employee's personal information 1602, delete employee 1608, go to the Employee's Visits (e.g., encounters) 1604, go to assign clients 1606, or return to the Employee List.

From the screen, a central office staff user can update any information in the Employee's personal information that is displayed in template form. Changes are saved in the system by clicking on the “Update” button 1602. If a central office staff user changes data in the client's personal information, the changes are saved only if the central office staff user clicks on the “Update” button 1602 before clicking on any other option. For example, if the central office staff user clicks on the “Visits” button 1604 before clicking on the “Update” button 1602, then any changes will be lost.

If a central office staff user elects to go to an employee's visits by clicking on the “Visits” button 1604, then execution continues to program segment S153 in FIG. 15. If a central office staff user decides to go to Assign Clients by clicking on the “Assign Clients” button 1606, then execution continues to program segment S154. Although not shown (but shown, for example, in the menu bar in FIG. 6) if the central office staff user chooses to go to “Client” module, then execution proceeds to program segment S155. If the central office staff user chooses to go to “Personnel” module, then execution proceeds to program segment S156. If the central office staff user chooses to go to “Planner” module, then execution proceeds to program segment S157. If the central office staff user chooses to go to “Administration” module, then execution proceeds to program segment S158.

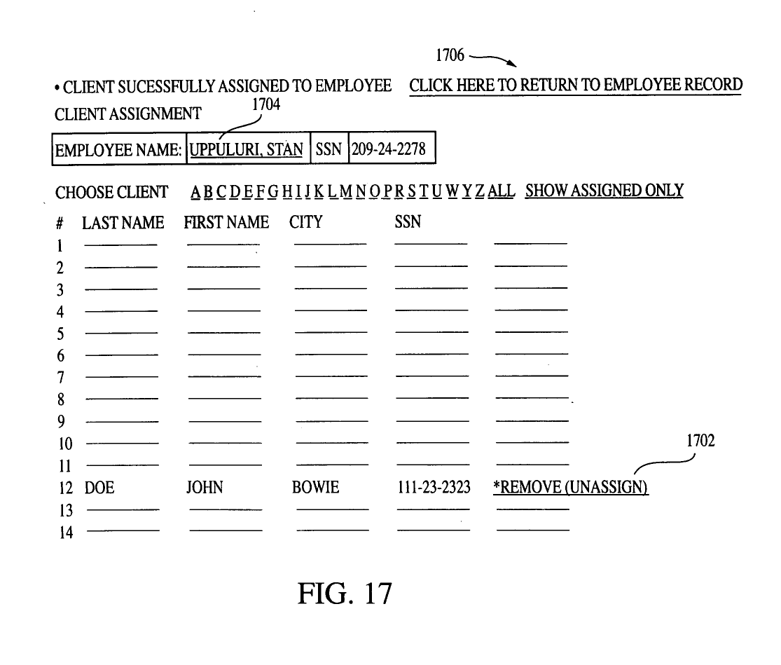

In program segment S152, a list of clients (Only one client is shown.) is displayed, which permits the central office staff user to assign listed clients to the employee, as shown in FIG. 17. A central office staff user can also unassign at 1702 clients from this employee. By clicking on the employee name 1704 or on “click here to return to employee record” 1706, execution continues to program segment S151.

In program segment S153, a list of client visits are displayed as shown in FIG. 9. A central office staff user can then approve any of the displayed visit(s). A central office staff user can also look at visits from the perspective of the client or in a tree by clicking on the appropriate button (e.g., “View”, “Tree”). A tree is a data structure having a root, branches, sub-branches and sub-sub-branches. The root is the starting point and may, for example, indicate ownership of the entire application (tree). The branches may be, for example, office sites. The sub-branches may, for example, be employees/providers working at a particular office site. Sub-sub branches may be the clients serviced by a particular provider. Clicking on the employee name continues execution to program segment S151.

In program segment S155, the Personnel Module has been chosen and execution continues to program segment S111.

In program segment S156, the Planner Module has been chosen and the user has the ability to execute different administrative protocols to manage the Planner—the scheduled encounters. As in a doctor's/provider's office, appointments, for example, are made and entries corresponding to those entries are made in the appropriate provider's calendar.

In program segment S157, the Administration Module has been chosen and the user has the ability to execute different administrative protocols to manage the overall system such as described above.

Operation of the Console Module of the Server Program

The console module of the server program is used to dynamically update the forms used by a specific partner or company supported or to dynamically generate new applications for a new partner, which may or may not be in the same industry. For example, the console module can use a set of master forms, which are templates, to create new applications for a pest control partner. Application creation requires no programming.

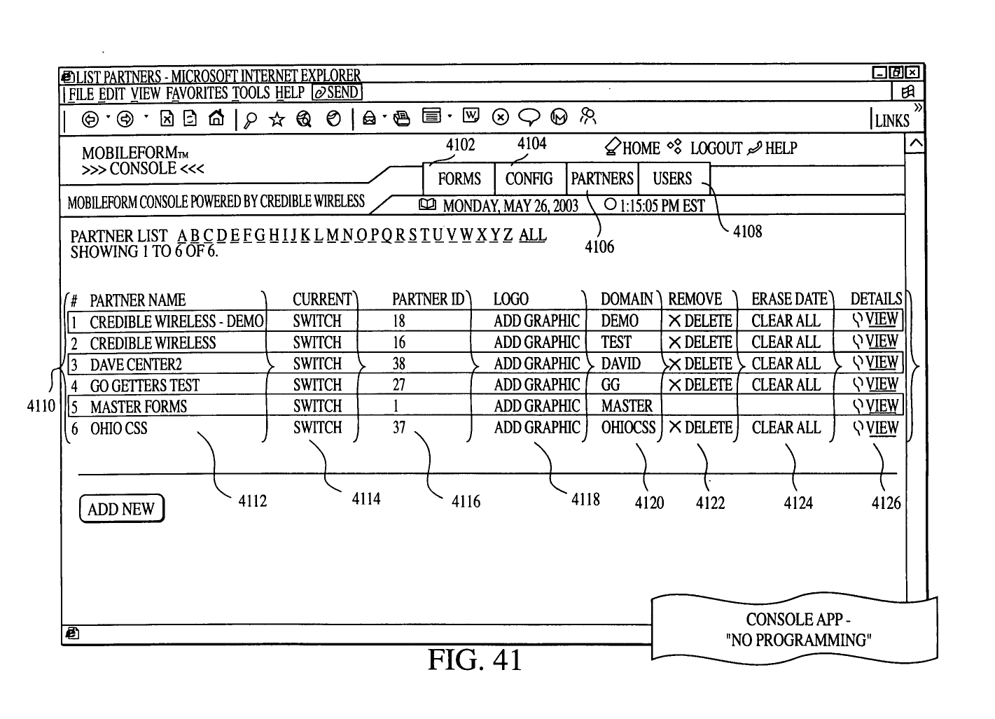

The main screen of the console module gives an authorized central office staff user four main options: forms 4102, config 4104, partners 4106 and users 4108. FIG. 41 is a representative partners screen. Information displayed on this screen includes an id number 4110, the names of the partners 4112, the current status 4114, a partner id 4116, an indication of the ability to add or change a logo 4118, the domain 4120 (who controls the application), an indication of the ability to remove the application entirely 4122, an indication of the ability to keep the application but to erase the data for the application 4124 and details 4126 via which details of an application can be viewed.

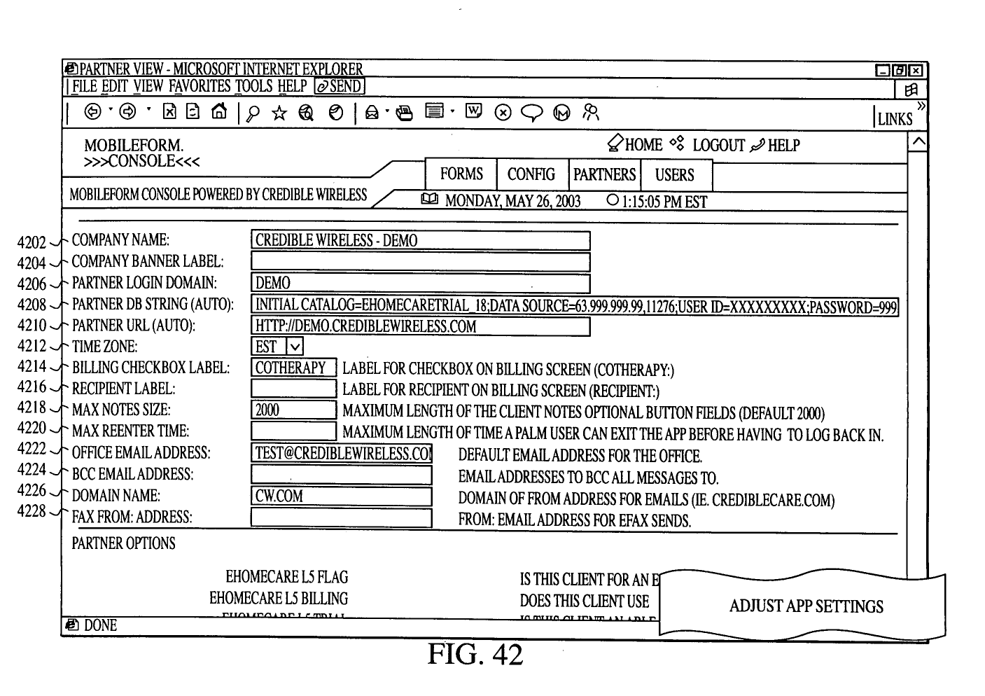

Application settings can be adjusted. For example, FIG. 42 shows the details of the Credible Wireless—Demo. As can be seen from this screen, the company name and partner domain match that on FIG. 41 for this partner. Any of the fields, except the fields marked “auto” can be changed. Information on this form includes Company Name 4202, Company Banner Label 4204, Partner Login Domain 4206, Partner DB String (auto) 4208, Partner URL (auto) 4210, Time Zone 4212, Billing Checkbox Label 4214, Recipient Label 4216, Max Notes Size 4218, Max Reenter Time 4220, Office Email Address 4222, BCC Email Address 4224, Domain Name 4226 and Fax from: address 4228. The Partner DB string is automatically generated by the system as is the Partner URL. All other fields may be updated or changed. The Time Zone field has a drop down to select from.

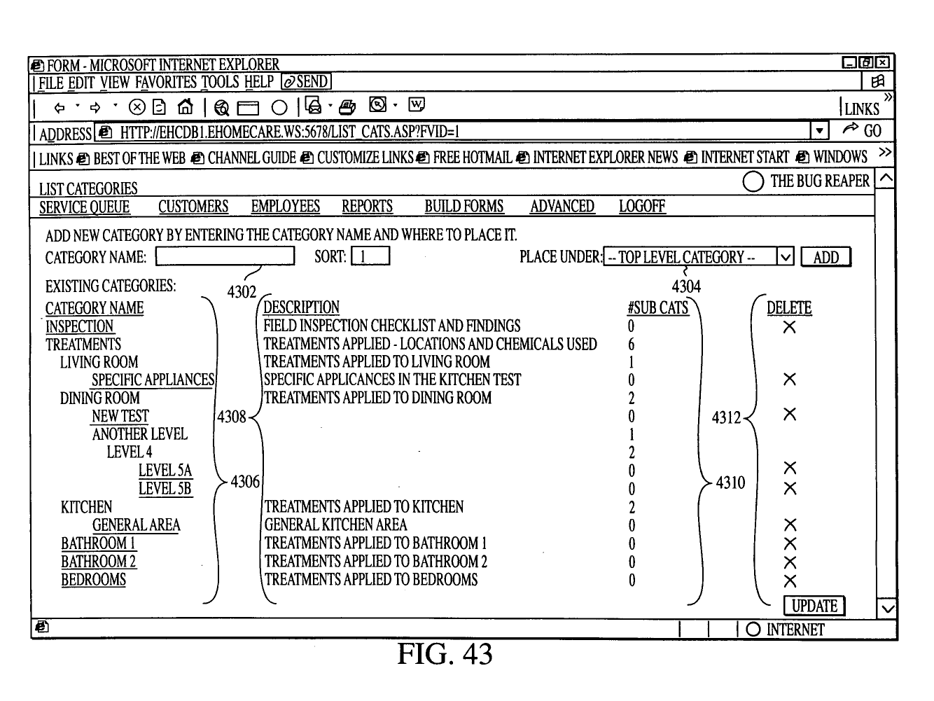

From the Forms option, a list of categories may be selected. In an exemplary case as shown in FIG. 43, the top level category selected may be inspections and another top level category might be treatments. Subcategories of treatments might include residential areas such as a living room, a dining room, a kitchen and a plurality of bedrooms. A new category may be added by giving the category a name in the Category Name box 4302 and indicating where to place the category in the Place Under box 4304. For example, a new category (subcategory) under dining room might be “New Test”. The name of the category might be “New Test” and it would be placed under “Dining Room”. The existing categories and subcategories are displayed on FIG. 43 including Category Names 4306, a Description 4308, the number of subcategories 4310 and an indication that the category may be deleted. Categories may be deleted if there are no subcategories or no further subcategories for the category or subcategory. In order to delete an entire category it would be necessary to delete all of its subcategories. Under treatments, for example, there are six subcategories. The subcategory “Specific Appliances”, which is a subcategory under the living room category has no further subcategories; so it may be deleted.

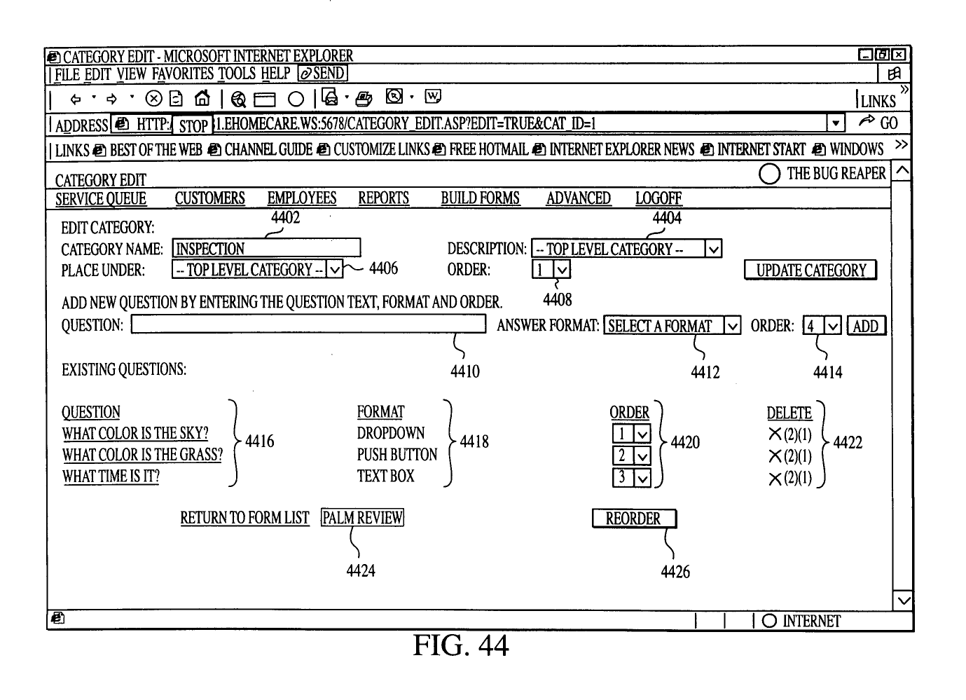

By clicking on the Category Name 4302 displayed in FIG. 43, it is possible to edit a category. FIG. 44 is a representative screen for editing the category “Inspection”. The Category Name 4402 and Description 4404 are filled in from the information in FIG. 43. For the category “Inspection”, FIG. 44 displays questions that are to be asked of a customer/client. The Place Under box 4406 is a drop down allowing the authorized central staff user to select the category under which the “Inspection” category is to be placed if it is necessary to move the selected category around. For example, if it is decided that “Inspection” is really a subcategory of another category and not at the top level, the category can be moved using the drop down Place Under 4406. The order for the category can be similarly selected using the Order drop down box 4408. If new or additional questions are to be created then the text of the new question can be entered in the Question box 4410. The Answer format for the question is selectable using the Answer Format drop down box 4412. The options for answers are drop down, push button, text box, check and radio box and date and time box. The order for the newly created or updated question can be selected from a drop down Order box 4414. Information on the “category Edit” screen displayed in FIG. 44 also includes a listing of the existing questions 4416, the format for the answers for each of the existing questions 4418, the order for each of the existing questions 4420 and an indication of whether or not the existing question may be deleted 4422. An existing question may not be deleted if it is a follow-up of a previous question and, therefore, depends upon an earlier question. It is possible to re-order the questions using the ReOrder button 4426.

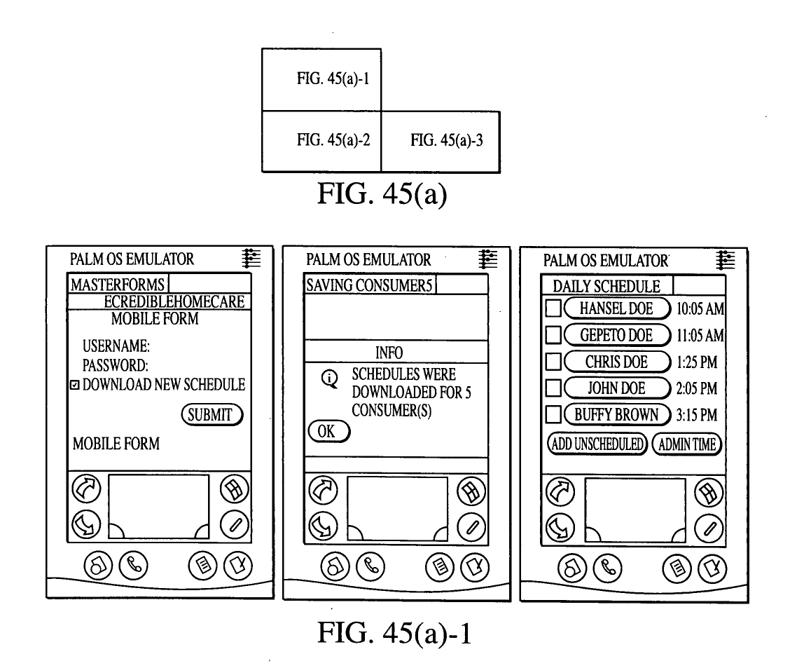

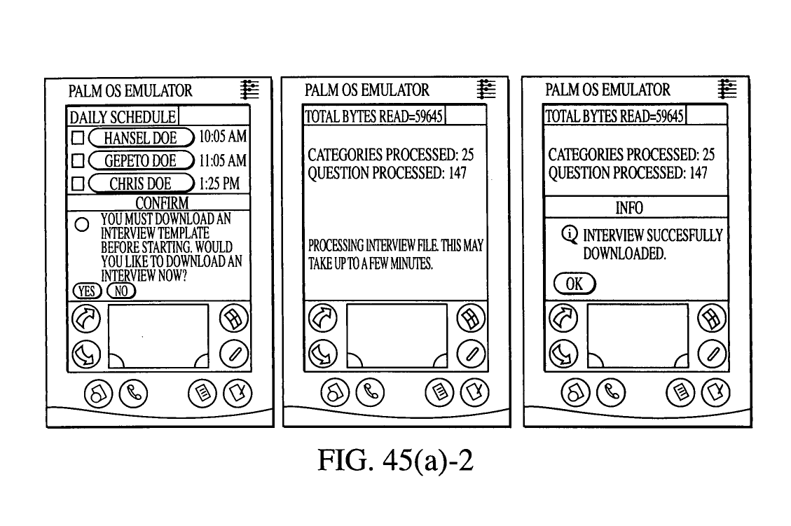

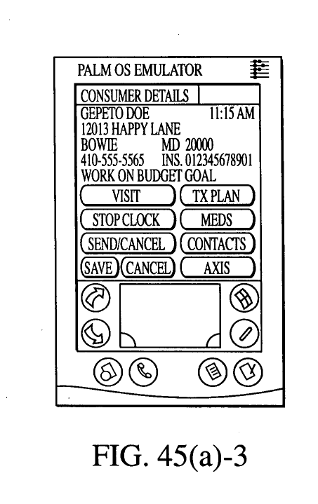

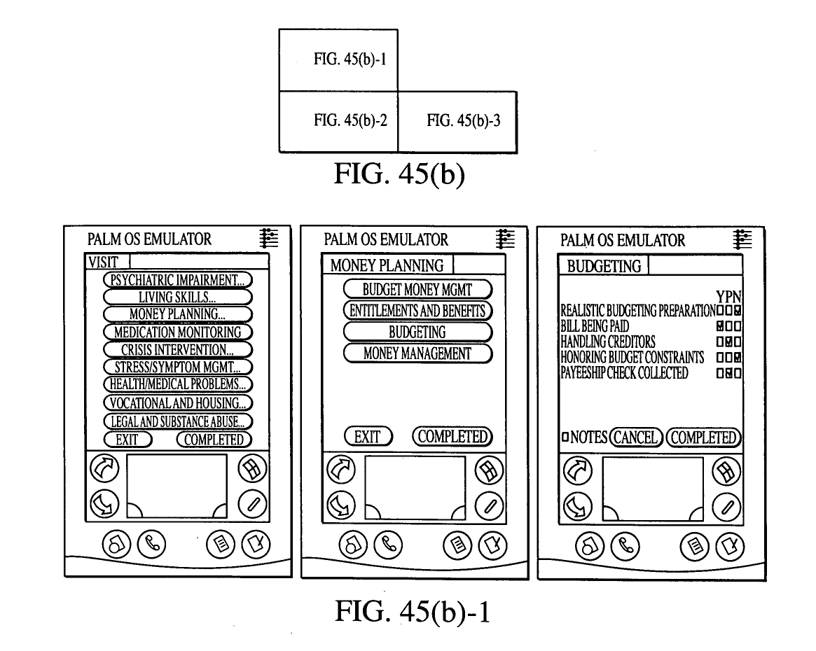

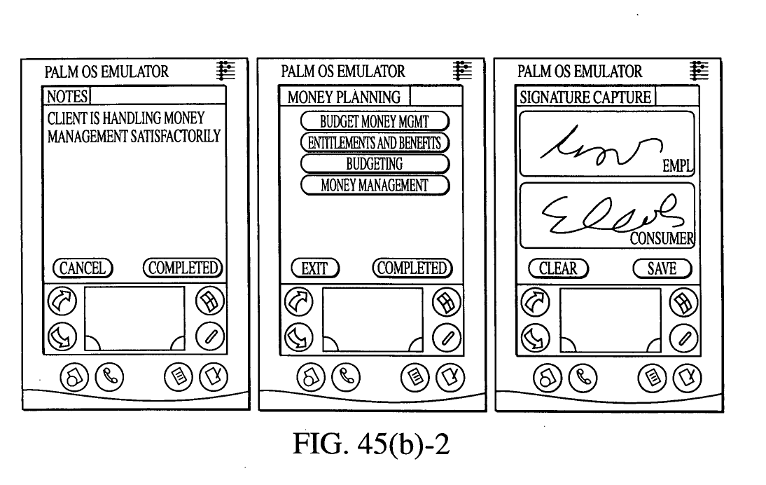

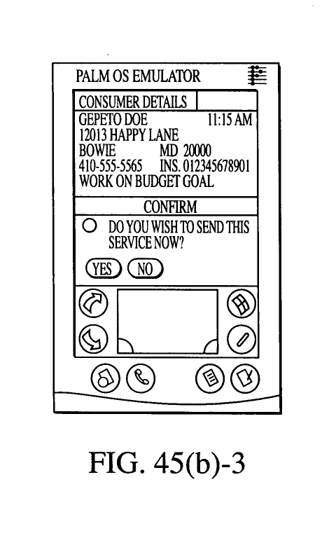

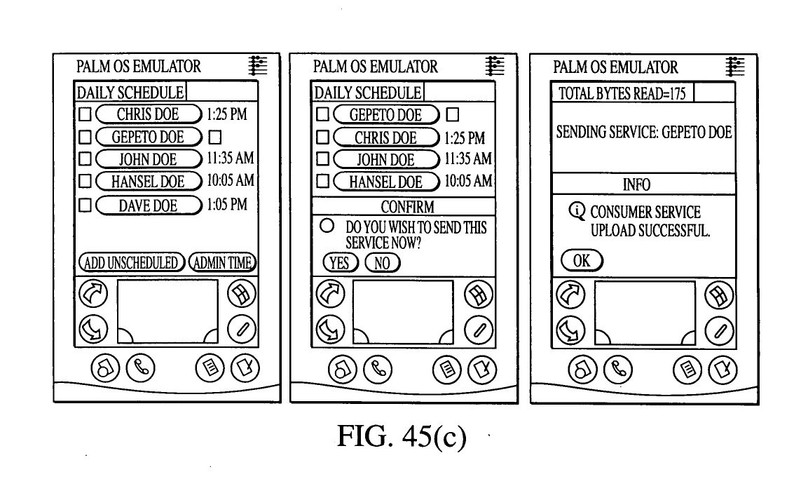

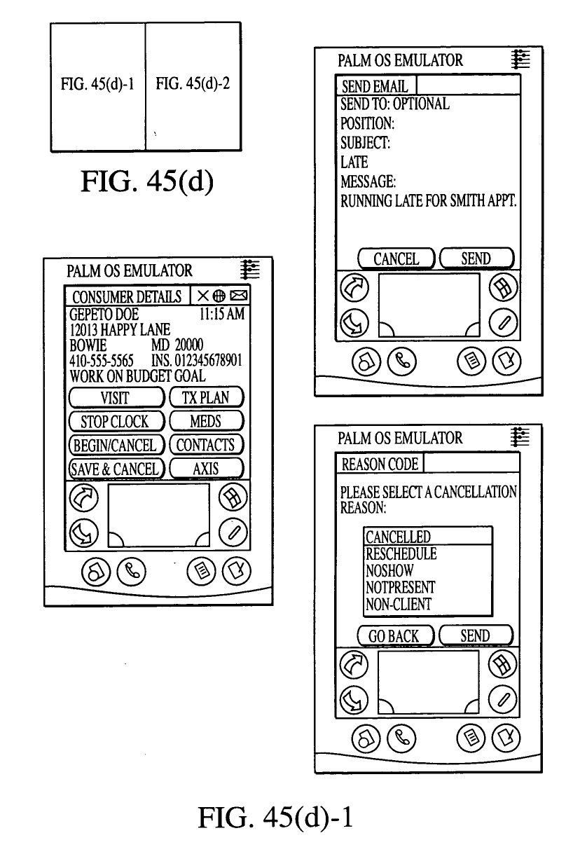

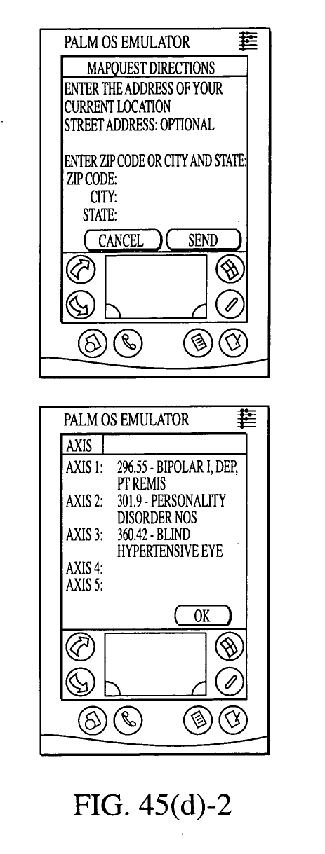

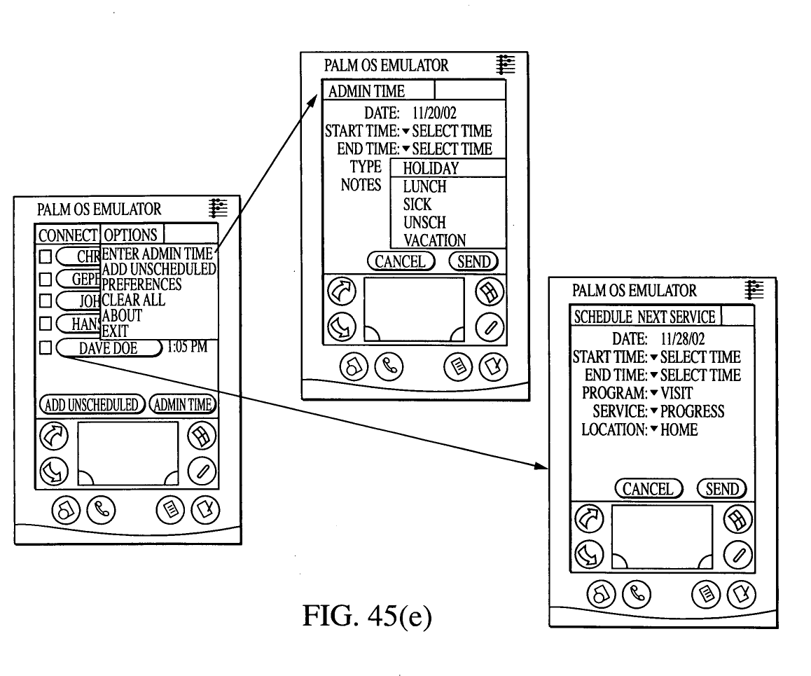

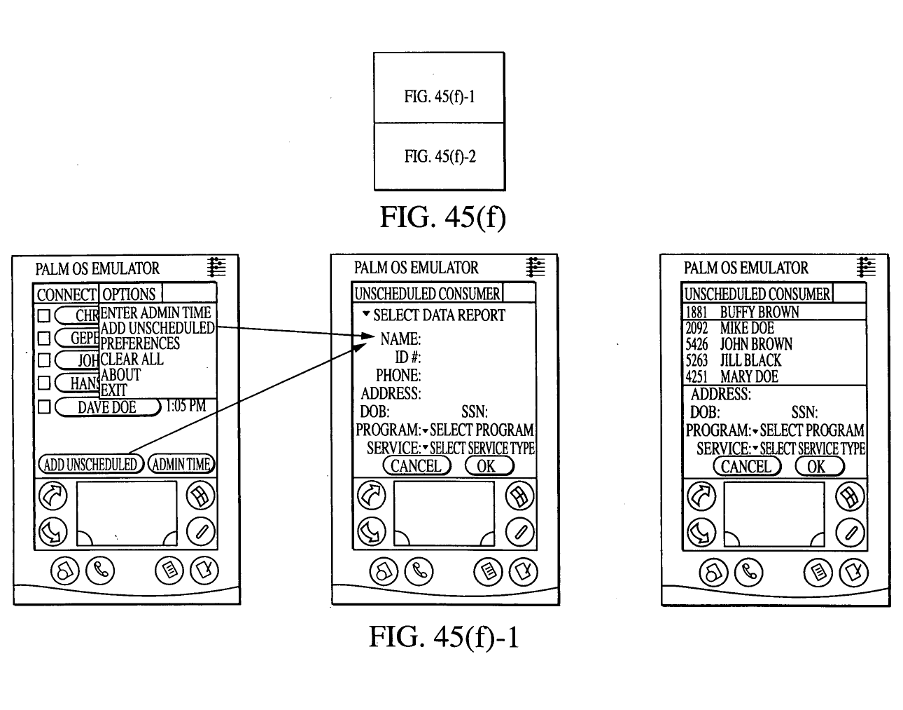

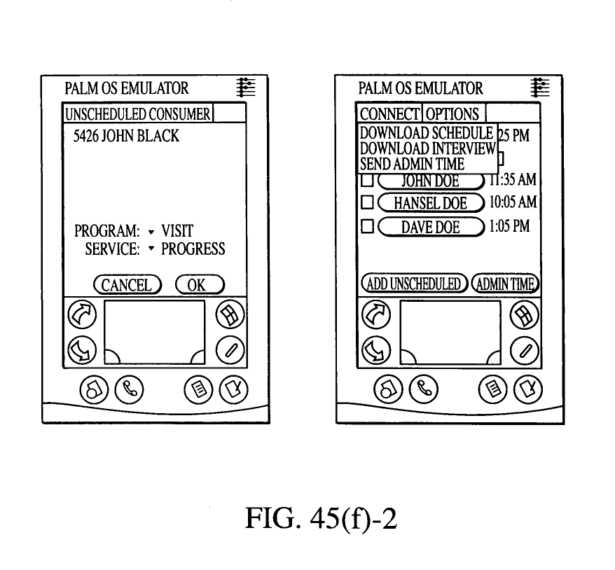

From screen illustrated in FIG. 44 it is also possible to preview via a PALM Emulator to show what the screen will look like for the field staff who are asking the questions and filling in the forms based on the customer's answers to the questions. This is accomplished using the PALM PREVIEW button 4424. FIG. 45(a) through (f) are examples of forms as previewed through the PALM PREVIEW option of FIG. 44. Beginning at the upper left of FIG. 45(a), the provider will be prompted to login by entering his/her username and password; Moving to the right, the provider would see the number of scheduled appointments he/she has. Continuing to the right, the provider would next see the names of the clients he/she is to see for the day. Moving to the far left bottom row, the provider would see the names of clients he/she is to see for the day that did not fit on the previous screen. The provider is queried if he/she would like to download the details of an interview/appointment. The download is commenced in the next screen and reported successfully completed in the following screen. The final screen of FIG. 45(a) shows the downloaded client details.

Beginning in the upper right corner of FIG. 45(b), the provider will be provided with a “Client Visit” emulated screen in order to address each issue and symptom for this client. This screen is different for each client. Next is “Money Planning” for this client including subcategories of “Money Planning” where the provider asks the client questions to determine if the client's goals are being met. In the next emulated screen, “Budgeting” is addressed, which is a subcategory of “Money Planning”. Next a “Notes” screen is emulated in which the provider can enter free form text as opposed to merely entering responses to questions. Next is another sample of a “Money Planning” emulated screen. Next is an emulated screen used for “Signature Capture” for capturing digital signatures using the stylus of the handheld computing device. The final emulated screen on FIG. 45(b) is a “Consumer Details” screen with a confirmation verification for the data for this client to be marked for forwarding back to the host processing system.

Beginning on the right of FIG. 45(c) is an emulate screen for a provider's “Daily Schedule”. The next emulated screen is for the provider's “Daily Schedule” and a request for confirmation to forward this data back to the host processing system. Upon confirmation of the request to forward the data, the next emulated screen confirms that the data was forwarded and how many bytes of data were forwarded.

Beginning on the left hand side of FIG. 45(d), is an emulated screen having “Consumer Details”. The “envelope” in the upper right of this emulated screen, if activated, results in “sending Email” as illustrated in the next emulated screen to the right. The next emulated screen is the result of activating the “globe” symbol and results in. directions to the client shown in the “Consumer Details” screen. The next emulated screen is the result of activating the “Send Cancel” appointment button. The next emulated screen is the result of activating the “Axis” button and indicates the diagnoses for this client.

Beginning on the left hand side of FIG. 45(e) is an “Options” emulated screen. The next emulated screen is the result of activating the option to enter “Admin Time”. The final emulated screen on FIG. 45(e) is the result of activating a “Schedule Next Service” button.

Beginning in the upper left hand corner of FIG. 45(f) is another example of the “Options” emulated screen. The next emulated screen is the result of activating the “Unscheduled Consumer” button. The next emulated screen gives the provider the option to select from among clients assigned to him/her but not scheduled for an appointment today. The next emulated screen indicates that the provider selected a client that was assigned to this provider but who did not have a scheduled appointment today. The final emulated screen of FIG. 45(f) is a “Connect” screen the allows the provider to attempt to download the client's information prior to commencing the appointment.

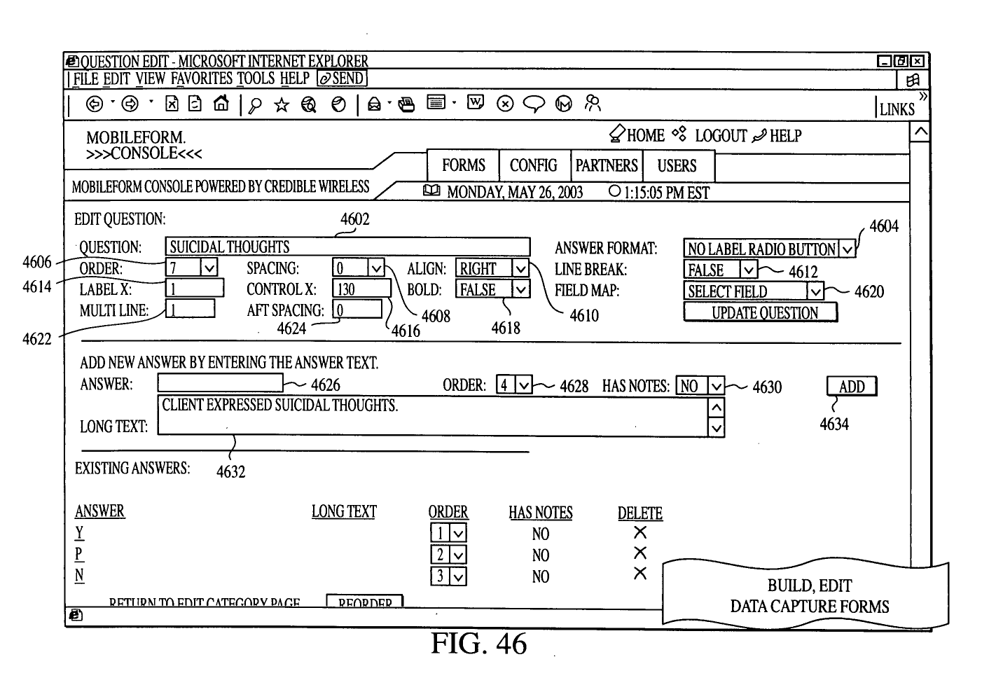

Clicking on an existing question listed on FIG. 44 permits editing of the existing question. A representative screen for editing a question is depicted in FIG. 46. The question appears in the Question box 4602 and the answer format appears in the drop down Answer Format box 4604. The order that the question appears on the screen of a PDA used by field staff is listed in the drop down Order box 4606. Other information includes a drop down box for Spacing 4608, a drop down box for Alignment 4610 of the question on the screen of the PDA, a drop down box for the inclusion of a Line Break 4612, a text box for the Label 4614, a text box for Control X 4616, a drop down box for an indication of whether the question should be in BOLD 4618, a drop down box for Field Map 4620, a text box for an indication of whether the question should be spread out over multiple lines (Multi Line) 4622 and a text box for spacing after the question 4624.

The lower portion of the Edit Question screen is for adding a new answer by entering answer text in a text box for the Answer 4626. The Order of this answer can be selected from the drop down box for Order 4628. An indication whether this question can have notes added by the field staff is selected from the drop down box for Has Notes 4630. The text of any notes for this question if permitted by an appropriate selection in the Has Notes drop down box is in the text box Long Text 4632. That is in addition to the answers for this question of Y=yes, N=no and P=possibly, a fourth answer is “Client has expressed suicidal thoughts”. Clicking the Add button 4634 updates the answers for this question to include the fourth answer discussed above.

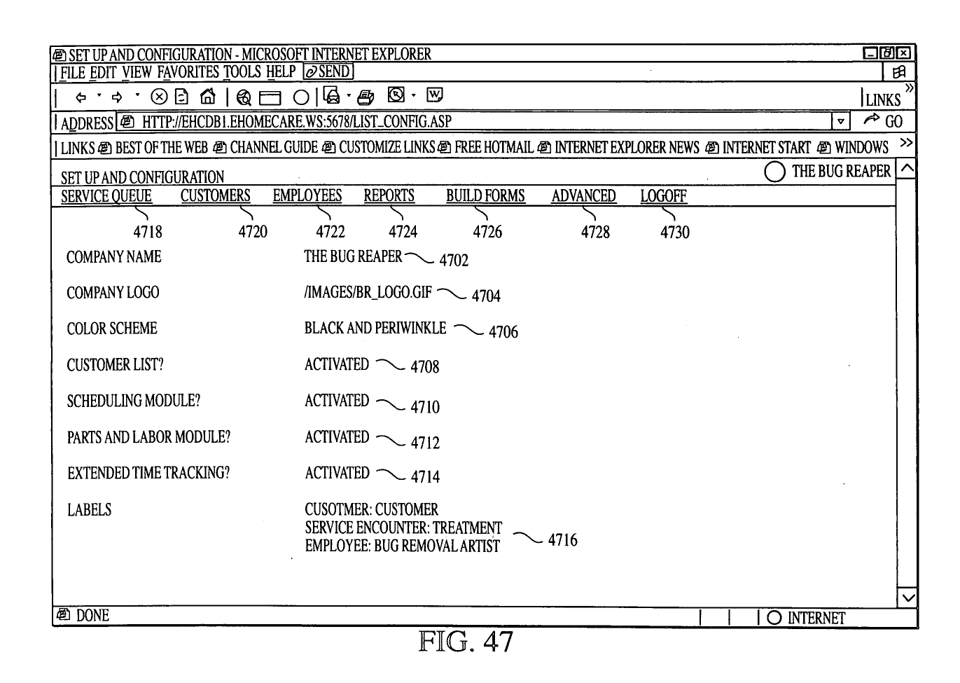

FIG. 47 is a representative configuration screen. The information displayed on this screen includes Company Name 4702, Company Logo 4704, which is a pointer to the file containing the company logo, Color Scheme 4706, the status of the Customer List 4708, the status of the Scheduling Module 4710, the status of the Parts and Labor Module 4712, the status of Extended Time Tracking 4714 and Labels 4716 for the Customer, the Service Encounter and the Employee. From this screen an authorized central office staff user has the option to enter the Service Queue 4718, set up a list of Customers 4720, set up a list of Employees 4722, set up and customize Reports 4724, Build the Forms 4726 that will be downloaded to field staff, address Advanced issues 4728 and logoff 4730.

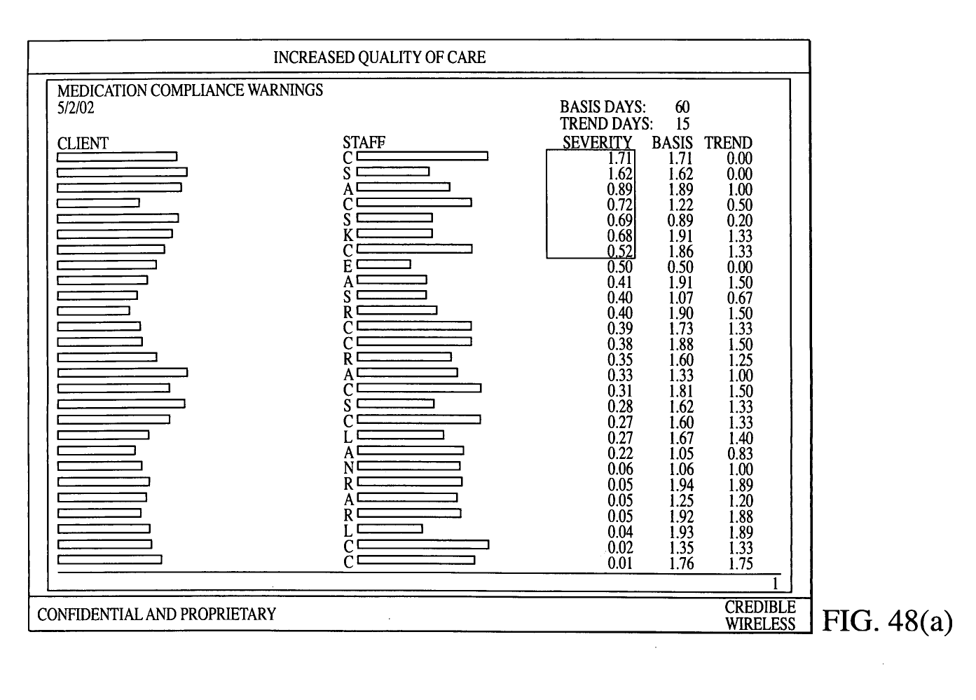

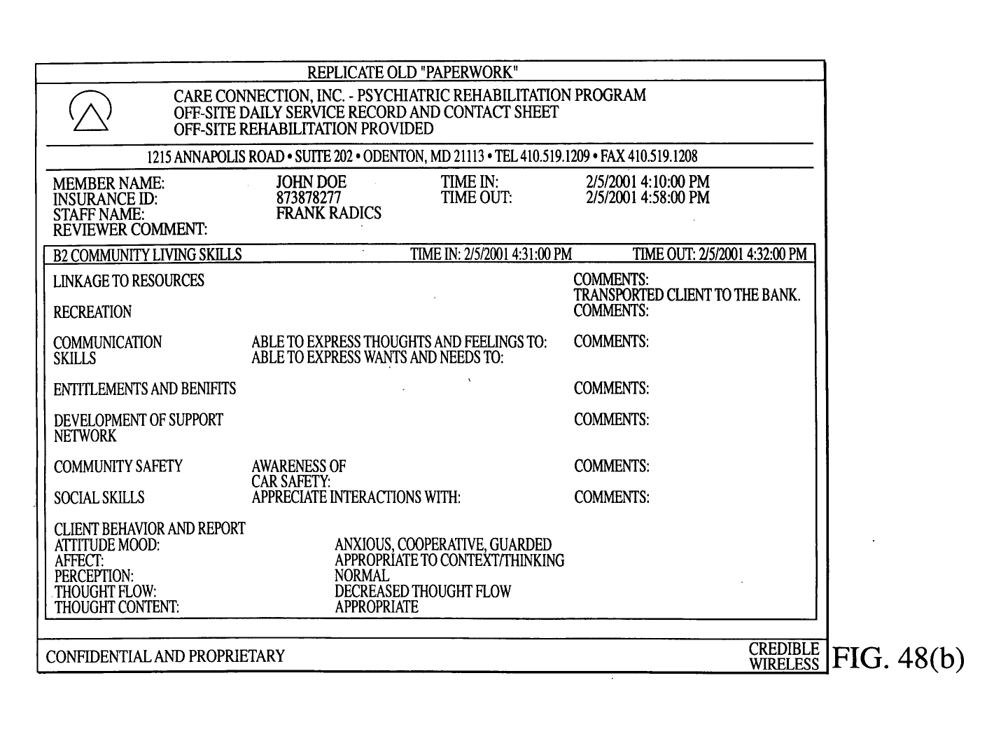

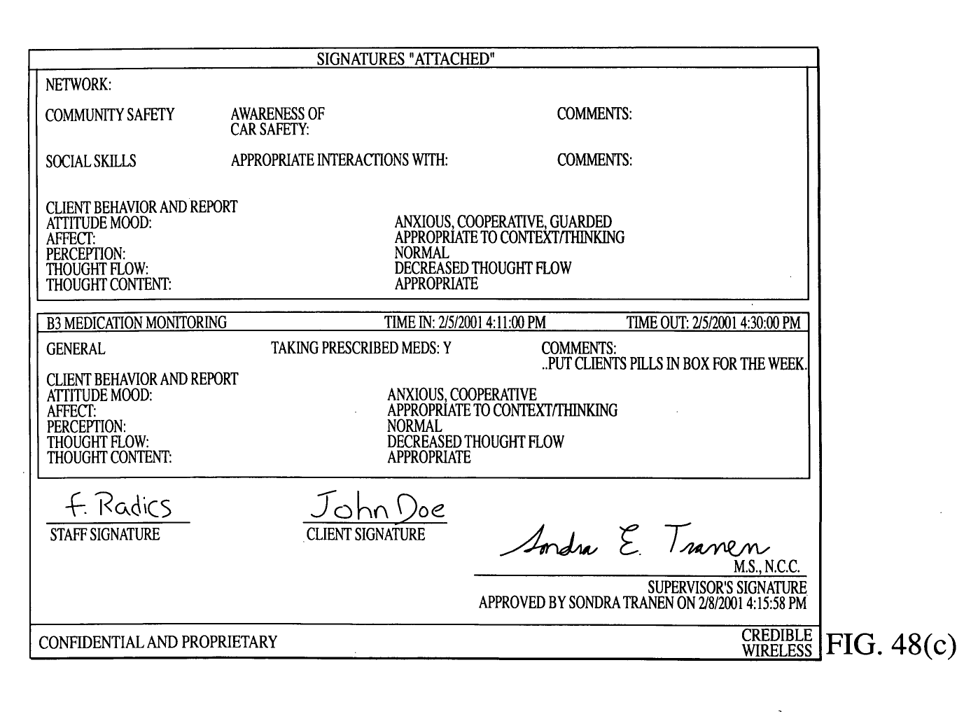

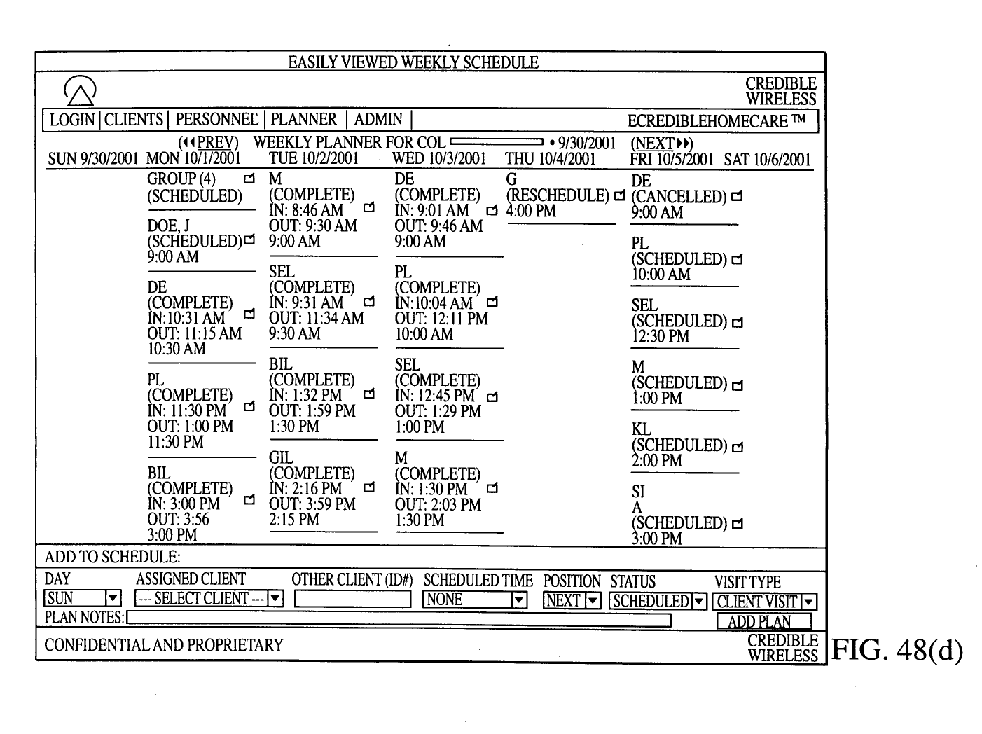

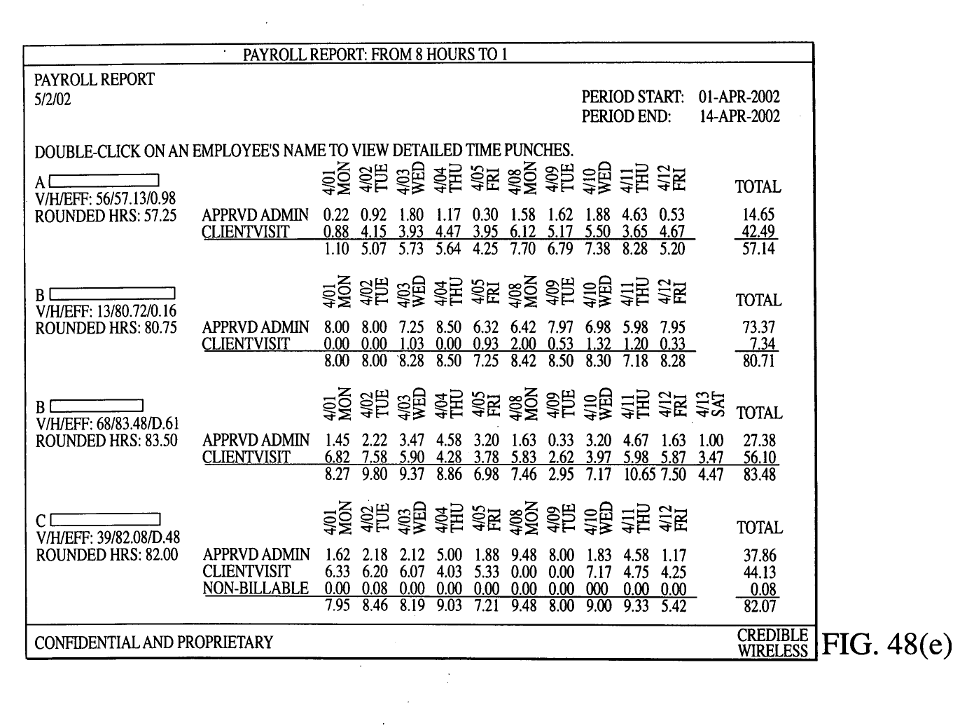

FIG. 48(a) is an exemplary screen showing the increased quality of care for clients who are “at risk” based on a severity rating. FIG. 48(b) is an example of a screen showing the results of importing data from a legacy system based on hard copy/paper. FIG. 48(c) is an exemplary screen, including digital signatures captured for the client and the provider. This screen illustrates a client behavior and report and medication monitoring. FIG. 48(d) is an exemplary weekly schedule for a provider. FIG. 48(e) is an exemplary provider payroll report.

Operation of the Field Component Program

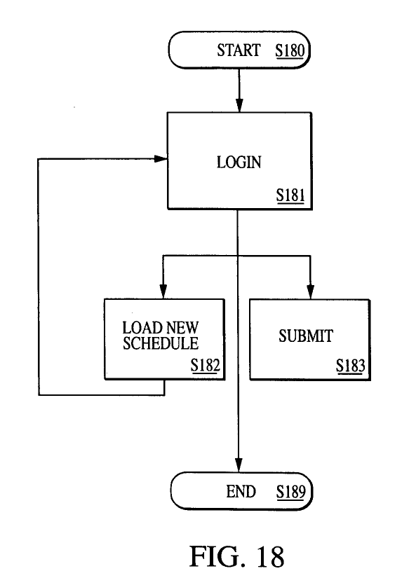

Execution of the field component is shown in the diagram of FIG. 18, which is a simplified flow operation of an exemplar embodiment of the present invention.

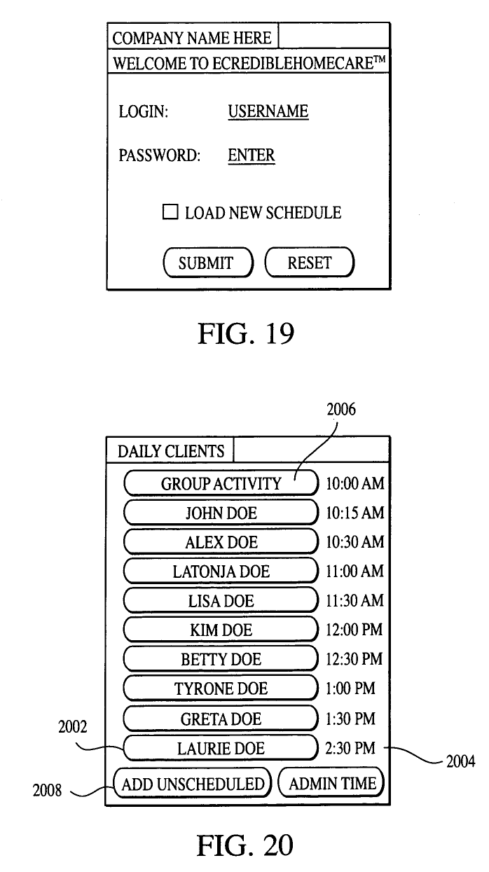

Running the electronic behavioral health care management data system remotely system begins when a field employee starts execution by tapping on the icon for the program, which displays the Welcome Screen, as seen in FIG. 19. The employee continues execution by logging into the system, program segment S181. This step permits the employee using the remote system to begin running the program that is contained in the memory of the PDA. After receiving an acceptable username and password, the system execution proceeds to program segment S182 if “Load New Schedule” 1902 is checked. After receiving an acceptable username and password, the system execution proceeds to program segment S183 if “Submit” 1904 is checked.

In program segment S182, the remote system 110 establishes a secure connection to the server system 130. After establishing a connection with the server 130 and finding the employee's Planner, the employee's schedule for the current day is downloaded to the remote PDA system 110 and displayed, as seen in FIG. 20. If an employee has more than ten scheduled encounters for the current day, only the first ten encounters are downloaded and stored in the memory of the remote system. (Additional encounters can be downloaded at a later time, as explained below). Program execution continues to program segment S181.

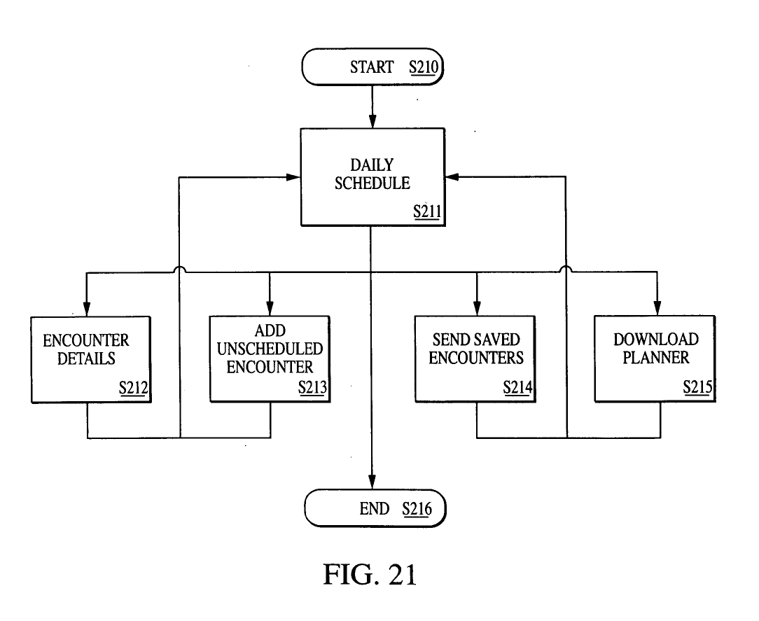

In program segment S183, program execution continues to program segment S211, “Daily Schedule” FIG. 21.

In program segment S211, the employee's schedule including encounters 2002 and encounter times 2004 for the day is displayed as shown in FIG. 20 (up to ten encounters). If the encounter is a group encounter then “Group Activity” is displayed for the encounter 2006. If the encounter is an individual encounter then the client's name is displayed for that encounter. The employee may view encounter, details and start the encounter, add an unscheduled encounter, send saved encounters, download additional encounters, or send a command (e.g., “email”) that sends a secure message to the server which in turn generates and sends a secure email message.

If an employee decides to go to Encounter details by tapping on the encounter, then execution continues to program segment S212. If a user decides to Add an unscheduled encounter by tapping on the “Add Unscheduled” button 2008, then execution continues to program segment S213. If a user decides to Send a saved Encounter by tapping on an “S” appearing next to an Encounter 212, then execution continues to program segment S214 (not shown). If a user decides to Download additional encounters for the current day by tapping on the PDA option button and then choosing “download planner,” then execution continues to program segment S215 (not shown).

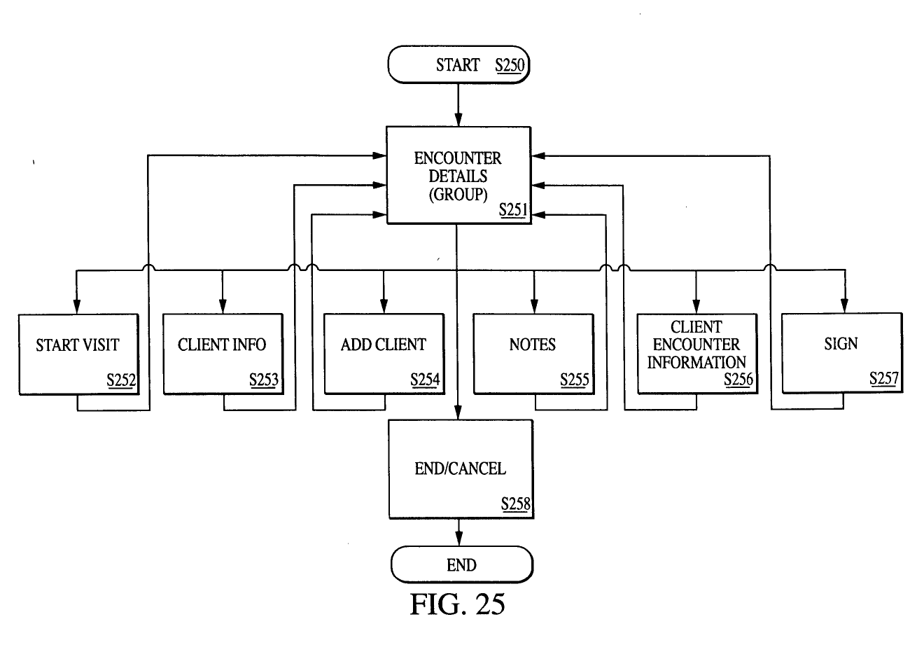

In program segment S212, if the encounter is an individual encounter, then execution continues to program segment S221. If the encounter is a group encounter, then execution continues to program segment S251 (FIG. 25).

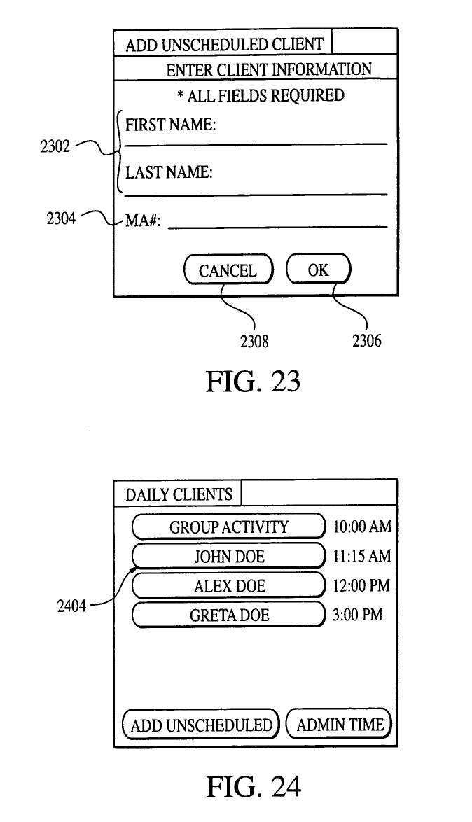

In program segment S213 (FIG. 21), an employee can add a previously unscheduled encounter to the employee's schedule of the current day. As shown in FIG. 23, the employee enters the client's name 2302 and additional identifying information, e.g., the medical assistance number 2304 , and the client is added to the schedule of day by tapping on “ok” 2306. The process can be canceled by tapping on the “cancel” button 2308 (FIG. 23). This assumes that there are not already ten scheduled encounters. If there are already ten scheduled encounters, then the new encounter will not be added. Program execution continues to program segment S211.

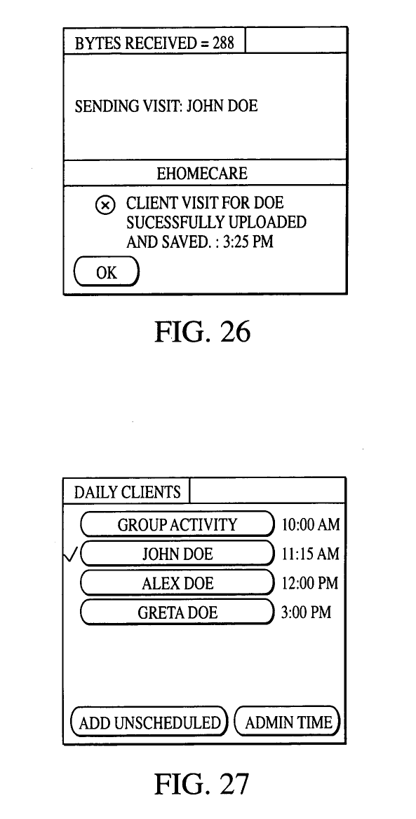

In program segment S214, the user desires to save an encounter. To save an encounter it must be previously marked for saving (an encounter is marked for saving after an encounter is successfully completed as described below). An encounter marked for saving is indicated by a symbol, e.g., an “S”, next to the encounter 2404 in the displayed schedule, as shown in FIG. 24. The program will ask for confirmation of the transmittal and will provide a message box indicating the status of the transmittal. For example, a box will be displayed indicating a successful transmission as shown in FIG. 26. The schedule of the day will again be displayed, but the encounter that was successfully transmitted will no longer have an “S” associated with the encounter, but a checkmark symbol will appear in its place as shown in FIG. 27. Program execution continues to program segment S211.

In program segment S215, assuming successful transmission, the server 130 will provide the PDA 110 with an updated schedule, removing the encounters already seen and adding any additional encounters (up to a maximum of ten total). Execution continues to program segment S211.

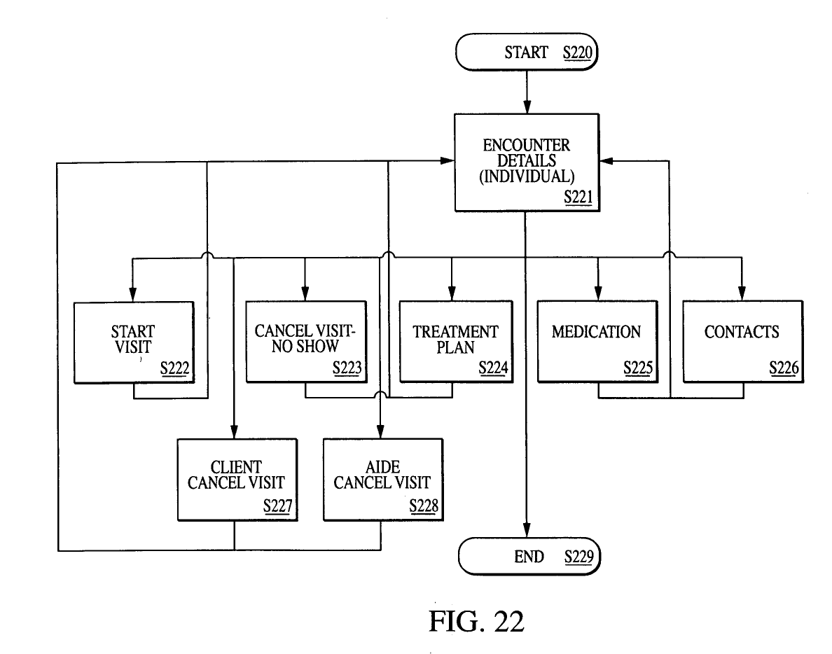

As shown in FIG. 22, in program segment S221, limited details about the encounter are shown. On the screen, for example, the client's name, address, phone, insurance number and appointment times are displayed (as seen in FIG. 28). An employee may choose to start an encounter, cancel the encounter, review the client's treatment plan, review the client's medications, review the client's contact information or generate a secure command which causes the server to produce a secure email. (FIG. 28)

If an employee decides to start an encounter by tapping on the “Start Visit” button 2802, then execution continues to program segment S222. If an employee decides to cancel an encounter by tapping the appropriate reason for canceling the appointment, e.g., the client fails to appear for the encounter 2808, the client cancels 2806, or the employee (e.g., the aide) cancels 2804, then the program execution continues to program segment S223, S227 or S228, respectively. If an employee decides to view the client's treatment plan by tapping on the “Tx Plan” button 2810, then execution continues to program segment S224. If an employee decides to view the client's medications by tapping on the “Meds” button 2812, then execution continues to program segment S225. If an employee decides to view the client's contacts by tapping on the “Contacts” button 2814, then execution continues to program segment S226. If an employee taps on “Go back” 2816 then execution continues to program segment S221. By clicking on email button 2818, an employee can send a command (e.g., “email”) that sends a secure message to the server, which in turn generates and sends an email message.

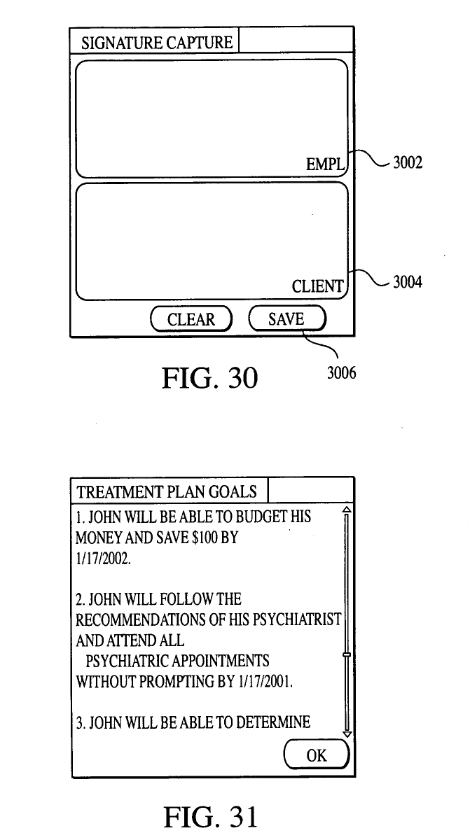

In program segment S222, the employee is provided a series of questions to be answered by the client. The client's answers are entered by the Employee on the PDA. An answer can take several forms: for example, it may be a check box, a pull down box that provides a series of possible answers, or a data entry form where the Employee writes a response that is captured. Questions are separated into categories 2902 and can be related to the location of the encounter as shown in FIG. 29. An employee can proceed to different categories of questions in any order. The order of questions within the categories must be answered in the order presented. The entry of each answer is time and date stamped. The questions and the questions of categories are created and established on the Server system. At any point, am employee can cancel or end the encounter. If the employee cancels the encounter 2904, then execution continues to program segment S211. If the employee ends the encounter 2906, then the employee is prompted for the client's 3002 and the employee's signature 3004, as shown in FIG. 30. In the exemplary embodiment, a proprietary algorithm for capturing and transmitting digitized signatures from handheld devices is used. The character-encoded line vector format is optimized for low bandwidth wireless connections, and travels to the data center in an XML message encrypted with 128-bit SSL. The encoded signature file is then translated to PNG and stored in a database in real time, where it can be easily retrieved for display in a web application or on printed documents. After completing the signatures and indicating that the encounter is to be saved by tapping on save button 3006, the encounter is marked for saving. Execution continues to program segment S211.

In program segment S223, the employee taps “No show” to indicate that the reason that the encounter is being cancelled is that the client failed to appear for the encounter. When an encounter is cancelled, an “X” is associated with the encounter in the schedule of the day. The cancelled encounter is transmitted back to the server reflecting that the encounter was cancelled and the reason. When completed, program execution returns to program segment S211.

In program segment S224, the employee is provided with the client's treatment plan for review. FIG. 31. When completed reviewing, program execution returns to program segment S221.

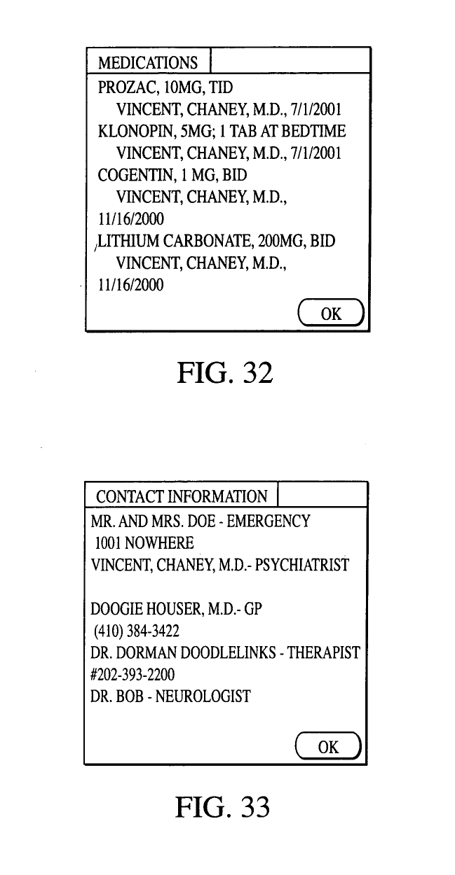

In program segment S225, the employee is provided with the client's medications for review as shown in FIG. 32. When the review is completed, program execution returns to program segment S221.

In program segment S226, the employee is provided the with the client's contacts for review. FIG. 33. When completed reviewing, program execution returns to program segment S221.

In program segment S227, the employee taps “Client Cancel” (2806, FIG. 28) to indicate that the reason that the encounter is being cancelled is that the client has decided not to have the encounter. When an encounter is cancelled, an “X” is associated with the encounter in the schedule of the day. The cancelled encounter is transmitted back to the server reflecting that the encounter was cancelled and the reason. When completed, program execution returns to program segment S211.

In program segment S228, the employee taps “Aide Cancel” (2804, FIG. 28) to indicate that the reason that the encounter is being cancelled is that the employee has decided not to have the encounter. When an encounter is cancelled, an “X” is associated with the encounter in the schedule of the day. The cancelled encounter is transmitted back to the server reflecting that the encounter was cancelled and the reason. When completed, program execution returns to program segment S211.

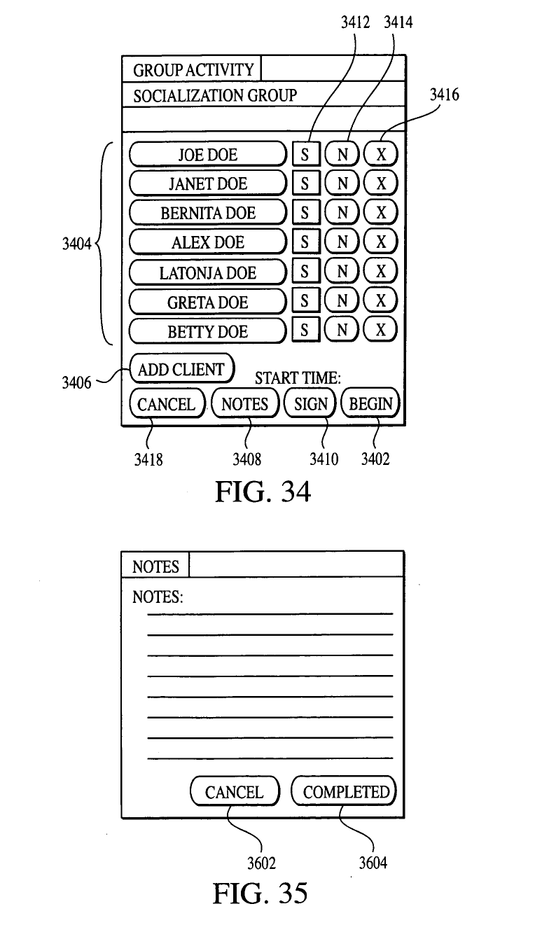

In program segment S251, limited details about the encounter are shown in FIG. 34. On the screen, for example, is a list of the clients' names that constitute the group. An employee may choose to start an encounter, cancel the encounter, review a client's information, modify a client's information regarding the encounter, add notes to the encounter, add the employee's signature to the encounter, or end/cancel the encounter.

If an employee decides to start an encounter by tapping on the “Begin” button 3402, then execution continues to program segment S252. If an employee decides to view the client's information by tapping on the client's name 3404, then execution continues to program segment S253. If an employee decides to add a client to the group by tapping on the “Add Client” button 3406, then execution continues to program segment S254. If an employee decides to add notes to the encounter by tapping on “Notes” 3408, then the program execution continues to program segment S255. If an employee decides to add notes/information to a client regarding the encounter this is accomplished by tapping on “N” 3414, then the program execution continues to program segment S255. If an employee elects to have a client sign regarding the encounter, this is accomplished by tapping “S” 3412 beside the client's name. If a client is a “no show” for the Group Activity, then the employee indicates that event by tapping “X” 3416 beside the client's name. If an employee decides to add their signature to the encounter by tapping “Sign” 3410, then the program execution continues to program segment S257. If an employee decides to cancel or end by tapping the appropriate reason for concluding the encounter, e.g., “End” (not shown) or “Cancel” 3418, then the program execution continues to program segment S258.

In program segment S252, the system notes the current time as the starting time for the encounter and execution continues to program segment S251.

In program segment S253, information about the client is displayed for the employee as shown in FIG. 28. The employee can view the client's basic information, the client's medications, the client's contact information, and the client's treatment information. For example, the displays would show information like that shown in FIGS. 27, 30, 31, 32, 34. When completed, execution returns to program segment S251.

In program segment S254, an employee can add an additional client to the Encounter group. When completed, execution continues to program segment S251.

In program segment S255, a notes screen is displayed and the employee can enter notes about the group session as shown in FIG. 35. If the employee taps on “cancel,” 3602 then program execution continues to program segment S251. If the employee taps on “Completed” 3604 then the notes are saved and the program execution continues to segment S251.

In program segment S256, if “S”, which indicates “Signature”, was tapped, then a screen, similar to that shown in FIG. 29, is displayed that enables capturing the client's signature. After capturing the signature, program execution continues to S251. If “N” which indicates “Notes”, was tapped, then a screen, similar to FIG. 35, is displayed and the employee is able enter notes about this client. After the notes are entered (or cancelled) the program execution continues to S251. If “X” is tapped, which indicates that the client did not show for the group encounter, the program then notes this entry and execution continues to program step S251.

In program segment S257, a screen, similar to that shown in FIG. 30, is displayed that enables capturing the employee's signature. After capturing the signature, program execution continues to S251.

At any point, an employee can cancel or end the encounter, which is program segment 258. If the employee cancels the encounter, then execution continues to program segment S211. If the employee ends the encounter, then the encounter is marked for saving and execution continues to program segment S211.

While the invention has been described and illustrated with reference to specific exemplary embodiments, it should be understood that many modifications and substitutions can be made without departing from the spirit and scope of the invention. Although the embodiments discussed above describe specific hardware, software, operating systems, encryption methods and technology, the present invention is not so limited. In addition, although operational flows of embodiments of the invention have been depicted in connection with flow charts, it should be readily understood that the particular order of the operations described therein is not necessarily critical, and may be modified to combine, eliminate or further separate the program segments and still maintain the spirit of the invention. Furthermore, although the invention has been described for use with specific program and component organization, the invention may be utilized in any system that permits data management reflective of the spirit of the invention. Accordingly, the invention is not to be considered as limited by the foregoing description but is only limited by the scope of the claims.

What is claimed as new and desired to be protected by Letters Patent of the United States is:

1. An information data management system for managing client information and encounters, comprising:
a host processing system that manages and maintains said client information and encounters; and
a handheld remotely operated processing system that receives data from said host processing system, modifies said data, and stores said data to be forwarded to said host processing system at a different time.

2. The information data management system according to claim 1, wherein said host processing system further controls means by which data is managed and captured.

3. The information data management system according to claim 2, wherein said means by which data is managed and captured includes data capture screens built dynamically by a module of said host processing.

4. An apparatus for electronically capturing data remotely comprising a handheld computing device, said handheld computing device capable of storing said captured data and forwarding said captured data to a server via a gateway.

5. The apparatus according to claim 4, wherein said gateway comprises:
a communications line between said server and a carrier proxy server;
a communications tower in communication with said carrier proxy server; and
a wireless communications link between said communications tower and said handheld computing device.

6. The apparatus according to claim 5, wherein said server downloads data to said handheld computing device via said gateway, said downloaded data being encrypted using a first encryption standard.

7. The apparatus according to claim 6, wherein said handheld computing device uses said downloaded data to capture data remotely and uploads said captured data merged with said downloaded data to said server when a communications link between said handheld computing device and said server can be established, said uploaded merged data being encrypted using a second encryption standard.

8. The apparatus according to claim 7, wherein said carrier proxy server performs a translation between said first encryption standard and said second encryption standard.

9. The apparatus according to claim 8, wherein at all times when data is being communicated there is at least one layer of security for said data.

10. The apparatus according to claim 7, wherein said uploaded merged data is forwarded using extended mark-up language (XML) blocks.

11. The apparatus according to claim 7, wherein said merged data is stored by said handheld computing device until said data can be forwarded to said server upon establishment of a communications link to said server via said gateway.

12. The apparatus according to claim 11, wherein said downloaded data and said merged data are stored in a compressed extended mark-up language (XML) form.

13. The apparatus according to claim 12, wherein said downloaded data includes forms, stored in compressed XML form, said stored compressed forms being retrieved by a rendering engine, said rendering engine generating data capture screens using said stored compressed forms.

14. The apparatus according to claim 7, wherein said downloaded data, said captured data and said merged data are described using extended mark-up language (XML) data type definitions (DTDs).

15. A method for electronically capturing data remotely, said method comprising:
establishing a first connection by a server with a remote handheld computing device via a gateway at a first time;
downloading data from said server to said remote handheld computing device via said gateway,
storing said downloaded data on said handheld computing device;
disconnecting said server and said handheld computing device from said first connection;
capturing data remotely using said downloaded data and said handheld computing device;
storing said captured data in said handheld computing device;
establishing a second connection with said server via said gateway by said handheld computing device at a second time; and
forwarding said captured data to said server over said second connection via said gateway.

16. The method according to claim 15, wherein said first and second connections are secure connections and said downloaded data is encrypted using a first encryption standard and said forwarded captured data is encrypted using a second encryption standard.

17. The method according to claim 15, further comprising:
merging said downloaded data and said captured data;
storing said merged data in said handheld computing device; and
forwarding said merged data to said server over said second connection via said gateway.

18. The method according to claim 16, wherein a carrier proxy server interposed between a communications tower of said gateway and said server performs a translation between said first encryption process and said second encryption process.

19. The method according to claim 18, wherein at all times when data is being communicated there is at least one layer of security for said data.

20. The method according to claim 17, wherein said forwarded merged data is forwarded using extended mark-up language (XML) blocks.

21. The method according to claim 17, wherein said merged data is stored by said handheld computing device until said data can be forwarded to said server upon establishment of a communications link to said server via said gateway.

22. The method according to claim 15, wherein said downloaded data and said captured data are stored in a compressed extended mark-up language (XML) form.

23. The method according to claim 17, wherein said downloaded data, said captured data and said merged data are described using extended mark-up language (XML) data type definitions (DTDs).

24. An apparatus for electronically capturing data remotely, comprising:
means for establishing a first connection by a server with a remote handheld computing device via a gateway at a first time;
means for downloading data from said server to said remote handheld computing device via said gateway;
means for storing said downloaded data on said handheld computing device;
means for disconnecting said server and said handheld computing device from said first connection;
means for capturing data remotely using said downloaded data and said handheld computing device;
means for storing said captured data in said handheld computing device;
means for establishing a second connection with said server via said gateway by said handheld computing device at a second time; and means for forwarding said captured data to said server over said second connection via said gateway.

25. The apparatus according to claim 24, wherein said first and second connections are secure connections and said downloaded data is encrypted using a first encryption standard and said forwarded captured data is encrypted using a second encryption standard.

26. The method according to claim 24, further comprising:
means for merging said downloaded data and said captured data;
means for storing said merged data in said handheld computing device; and
means for forwarding said merged data to said server over said second connection via said gateway.

27. An apparatus for electronically managing remotely captured data comprising a server having at least two modules, a first module of said server capable of storing data and forwarding said stored data to a remotely operated handheld computing device via a gateway, said remotely operated handheld device capable of storing said forwarded data.

28. The apparatus according to claim 27, wherein said gateway comprises:
a communications link between said first module of said server and a carrier proxy server;
a communications tower in communication with said carrier proxy server; and
a wireless communications link between said communications tower and said handheld computing device.

29. The apparatus according to claim 28, wherein said first module of said server downloads data to said handheld computing device via said gateway, said downloaded data being encrypted using a first encryption standard.

30. The apparatus according to claim 29, wherein said handheld computing device uses said downloaded data to capture data remotely and uploads said captured data merged with said downloaded data to said first module of said server when a communications link between said handheld computing device and said first module of said server can be established, said uploaded merged data being encrypted using a second encryption standard.

31. The apparatus according to claim 30, wherein said carrier proxy server performs a translation between said first encryption standard and said second encryption standard.

32. The apparatus according to claim 31, wherein at all times when data is being communicated there is at least one layer of security for said data.

33. The apparatus according to claim 30, wherein said uploaded merged data is forwarded using extended mark-up language (XML) blocks.

34. The apparatus according to claim 30, wherein said merged data is stored by said handheld computing device until said data can be forwarded to said first module of said server upon establishment of a communications link to said first module of said server via said gateway.

35. The apparatus according to claim 33, wherein said downloaded data and said merged data are stored in a compressed extended mark-up language (XML) form.

36. The apparatus according to claim 30, wherein said downloaded data, said captured data and said merged data are described using extended mark-up language (XML) data type definitions (DTDs).

37. The apparatus according to claim 27, wherein said server has a second module, said second module of said server in communications with said first module of said server, and further wherein each of said first module of said server and said second module of said server has access to a database management system for storing and retrieving data including forms for use in capturing data by said remotely operated handheld computing device.

38. The apparatus according to claim 37, wherein said second module of said server includes a plurality of submodules, said plurality of submodules includes a submodule for communicating with said first module of said server, a submodule for emulating screens for said handheld computing device and a dynamic applications generator submodule for one of updating forms of a current application and creating a new application.

39. The apparatus according to claim 38, wherein new applications are created using a library of pre-defined business forms, which said dynamic applications generator submodule customizes.

40. The apparatus according to claim 39, wherein said pre-defined business forms include categories, subcaterories, questions and answers.

41. A method for electronically managing remotely captured data, said method comprising:
retrieving data from a database management system;
establishing a first connection by said server with said remotely operated handheld computing device at a first time via a gateway;
downloading data from said server to said remotely operated handheld computing device via said gateway;
establishing a second connection by said remotely operated handheld computing device with said server at a second time; and
uploading merged data to said server by said remotely operated handheld computing device over said second connection via said gateway.

42. The method according to claim 41, further comprising storing said merged data in said database management system.

43. The method according to claim 42, further comprising:
editing said merged data; and
batching said edited merged data.

44. The method according to claim 43, further comprising:
filing said batched data with a third party;
receiving payments from said third party;
managing said received payments; and
reconciling said received payments with said filed batched data.

45. The method according to claim 42, wherein said first and said second connections are both secure connections.

46. The method according to claim 41, wherein said retrieved data includes forms, schedules and customer data.

47. The method according to claim 41, wherein said merged data includes said downloaded data updated using data captured by said remotely operated handheld computing device.

48. An apparatus for electronically managing remotely captured data comprising:
means for retrieving data from a database management system;
means for establishing a first connection by said server with said remotely operated handheld computing device at a first time via a gateway;
means for downloading data from said server to said remotely operated handheld computing device via said gateway;
means for establishing a second connection by said remotely operated handheld computing device with said server at a second time; and
means for uploading merged data to said server by said remotely operated handheld computing device over said second connection via said gateway.

49. The apparatus according to claim 48, further comprising means for storing said merged data in said database management system.

50. The method according to claim 49, further comprising:
means for editing said merged data;
means for batching said edited merged data;
means for filing said batched data with a third party;
means for receiving payments from said third party;
means for managing said received payments; and
means for reconciling said received payments with said filed batched data.

51. The apparatus according to claim 48, wherein said first connection and said second connection are both secure.

52. An apparatus for controlling means by which data is managed and remotely captured electronically, comprising:
a server having at least two modules, a first module of said server capable of storing data and forwarding said stored data to a remotely operated handheld computing device;
a second module of said server capable of storing data and forwarding said stored data to said first module of said server.

53. The apparatus according to claim 52, wherein said second module of said server includes a plurality of submodules, said plurality of submodules includes a submodule for communicating with said first module of said server, a submodule for emulating screens for said handheld computing device and a dynamic applications generator submodule for one of updating forms of a current application and creating a new application.

54. The apparatus according to claim 53, wherein new applications are created using a library of pre-defined business forms, which said dynamic applications generator submodule customizes.

55. The apparatus according to claim 54, wherein said pre-defined business forms include categories, subcaterories, questions and answers.

56. A method for controlling means by which care is managed and remotely captured electronically, said method comprising:
retrieving a set of forms for one of a current business application and a set of pre-defined business forms for use in creating a new business application by a first module of said server;
customizing said set of forms for one of said retrieved current business application and said new business application by editing categories, subcategories, questions and answers; and
storing one of said customized forms for said current business application and said customized set of forms for said newly created business application in a memory storage system.

57. The method according to claim 56, further comprising:
using an emulator for emulating screens of a handheld computing device such that handheld computing device screens displaying one of said customized forms and said newly created customized forms can be viewed;
performing said customizing, storing and using acts iteratively until one of said customized forms for said current business application and said customized forms for said newly created business application have a desired appearance; and
notifying a second module of said server by said first module of said server that one of said stored customized forms for said current business application and said stored newly created customized forms are available.

58. An apparatus for controlling means by which care is managed and remotely captured electronically, comprising:
means for retrieving a set of forms for one of a current business application and a set of pre-defined business forms for use in creating a new business application by a first module of said server;
means for customizing said set of forms for one of said retrieved current business application and said new business application by editing categories, subcategories, questions and answers; and
means for storing one of said customized forms for said current business application and said customized set of forms for said newly created business application in a memory storage system.

59. The apparatus according to claim 58, further comprising:
means for using an emulator for emulating screens of a handheld computing device such that handheld computing device screens displaying one of said customized forms and said newly created customized forms can be viewed;
means for performing said customizing, storing and using acts iteratively until one of said customized forms for said current business application and said customized forms for said newly created business application have a desired appearance; and
means for notifying a second module of said server by said first module of said server that one of said stored customized forms for said current business application and said stored newly created customized forms are available.

60. A store and forward system for managing electronically captured data comprising.
a server including at least two modules, a first module for generating means by which data is managed and captured and a second module for electronically managing data;
a database management system;
a client including a handheld computing device said handheld computing device capable of storing data forwarded by said second module of said server; and a gateway.

61. The system according to claim 60, wherein said gateway further comprises:
a carrier proxy server in communication with said server via a communications line;
a communications tower in communications with said carrier proxy server; and
a communications link between said communications tower and said client for communicating therebetween.

62. The system according to claim 61, wherein said server encrypts data for communication to said client using a first encryption standard and said client encrypts data for forwarding to said server using a second encryption standard.

63. The system according to claim 62, wherein said carrier proxy server performs a translation between said first encryption standard and said second encryption standard.

64. The system according to claim 63, wherein 'said data being communicated between said server and said client at all times has at least one layer of security.

65. The system according to claim 60, wherein data is sent by said client in extended mark-up language (XML) blocks.

66. The system according to claim 60, wherein said client stores forms in compressed extended mark-up language (XML) form.

67. The system according to claim 60, wherein said first module of said server performs the following functions:
configuring high-level application behaviors;
configuring and controlling screen fields;
dynamically outlining and building data capture forms;
dynamically updating data capture forms;
releasing new data capture forms and new versions of data capture forms to the field; and
emulating screens as said screens would be displayed on a handheld computing device.

68. The system according to claim 67, wherein said data capture forms include categories, subcategories, questions and answers.

69. The system according to claim 60, wherein said second module of said server performs the following functions:
supporting reviewing, editing, printing and approving of data capture forms uploaded from remotely operated handheld computing device;
supporting entering, listing, searching, viewing and updating of customer and field staff records;
supporting scheduling and schedule management;
supporting an integrated view of events and reminders;
supporting setting up work teams and assignments of work teams;
providing a plurality of pre-defined reports;
importing data records from a legacy system;
controlling security profiles;
enforcing security policies;
batching claims for filing of claims;
filing claims;
managing claims payments;
coordinating claims with insurance benefits; and
reconciling claims payments with filed claims.

70. The system according to claim 69, wherein supporting scheduling and schedule management includes entering and updating appointments/encounters.

71. The system according to claim 60, wherein said client performs the following functions:
selecting an operational mode for said handheld computing device;
downloading forms, schedules and customer information on demand;
rendering data capture screens using said downloaded forms, schedules and customer information;
scheduling encounters/appointments;
displaying customer information;
performing unscheduled services;
displaying running/elapsed time on said handheld computing device;
capturing data using downloaded forms, schedules and customer information; and
capturing a digitized signature using a stylus of said handheld computing device.

72. The system according to claim 71, wherein said operational modes include wireless, wireline and hotsync.

73. The system according to claim 71, wherein said displayed customer information is retrieved from one of said server, local cache and a newly created customer record.

74. The system according to claim 60, wherein said first module of said server further comprises:
means for configuring high-level application behaviors;
means for configuring and controlling screen fields;
means for dynamically outlining and building data capture forms;
means for dynamically updating data capture forms;
means for releasing new data capture forms and new versions of data capture forms to the field; and
means for emulating screens as said screens would be displayed on a handheld computing device.

75. The system according to claim 60, wherein said second module of said server further comprises:
means for supporting reviewing, editing, printing and approving of data capture forms uploaded from remotely operated handheld computing device;
means for supporting entering, listing, searching, viewing and updating of customer and field staff records;
means for supporting scheduling and schedule management;
means for supporting an integrated view of events and reminders;
means for supporting setting up work teams and assignments of work teams;
means for providing a plurality of pre-defined reports;
means for importing data records from a legacy system;
means for controlling security profiles;
means for enforcing security policies;
means for batching claims for filing of claims;
means for filing claims;
means for managing claims payments;
means for coordinating claims with insurance benefits; and
means for reconciling claims payments with filed claims.

76. The system according to claim 60, wherein said client module of said server further comprises:
means for selecting an operational mode for said handheld computing device;
means for downloading forms, schedules and customer information on demand;
means for rendering data capture screens from said downloaded forms, schedules and information;
means for scheduling encounters/appointments;
means for displaying customer information;
means for performing unscheduled services;
means for displaying running/elapsed time on said handheld computing device;
means for capturing data using downloaded forms, schedules and customer information; and
means for capturing a digitized signature using a stylus of said handheld computing device.

77. The system according to claim 60, wherein said server and said client each include computer readable media in which are stored programs and data.

78. The system according to claim 77, wherein said programs of said first module of said server perform the following functions:
configuring high-level application behaviors;
configuring and controlling screen fields;
dynamically outlining and building data capture forms;
dynamically updating data capture forms;
releasing new data capture forms and new versions of data capture forms to the field; and
emulating screens said screens would be displayed on a handheld computing device.

79. The system according to claim 77, wherein said programs of said second module of said server performs the following functions:
supporting reviewing, editing, printing and approving of data capture forms uploaded from remotely operated handheld computing device;
supporting entering, listing, searching, viewing and updating of customer and field staff records;
supporting scheduling and schedule management;
supporting an integrated view of events and reminders;
supporting setting up work teams and assignments of work teams;
providing a plurality of pre-defined reports;
importing data records from a legacy system;
controlling security profiles;
enforcing security policies;
batching claims for filing of claims;
tiling claims;
managing claims payments;
coordinating claims with insurance benefits; and
reconciling claims payments with filed claims.

80. The system according to claim 77, wherein said programs of said client module of said server performs the following functions:
selecting an operational mode for said handheld computing device;
downloading forms, schedules and customer information on demand;
rendering data capture screens using said downloaded forms, schedules and customer information;
scheduling encounters/appointments;
displaying customer information;
performing unscheduled services;
displaying running/elapsed time on said handheld computing device;
capturing data using downloaded forms, schedules and customer information; and
capturing a digitized signature using a stylus of said handheld computing device.

81. A method for operating a store-and-forward system for managing electronically captured data, said method comprising:
configuring high-level application behaviors;
configuring and controlling screen fields;
dynamically outlining and building data capture forms;
dynamically updating data capture forms;
releasing new data capture forms and new versions of data capture forms to the field; and
emulating screens as said screens would be displayed on a handheld computing device.

82. The method according to claim 81, further comprising:
supporting entering, listing, searching, viewing and updating of customer and field staff records;
supporting scheduling and schedule management;
supporting an integrated view of events and reminders;
supporting setting up work teams and assignments of work teams;
providing a plurality of pre-defined reports;
importing data records from a legacy system;
controlling security profiles; and
enforcing security policies.

83. The method according to claim 82, further comprising:
selecting an operational mode for said handheld computing device;
downloading forms, schedules and customer information on demand;
rendering data capture screens using said downloaded forms, schedules and customer information;
scheduling encounters/appointments;
displaying customer information;
performing unscheduled services;
displaying running/elapsed time on said handheld computing device;
capturing data using downloaded forms, schedules and customer information; and
capturing a digitized signature using a stylus of said handheld computing device.

84. The method according to claim 83, further comprising:
supporting reviewing, editing, printing and approving of data capture forms uploaded from remotely operated handheld computing device;
batching claims for filing of claims;
filing claims;
managing claims payments;
coordinating claims with insurance benefits; and
reconciling claims payments with filed claims.
